(19) United States
(12) Patent Application Publication
(10) Pub. No.: US 2015/0310485 A1
(43) Pub. Date: Oct. 29, 2015

(54) SYSTEMS AND METHODS FOR ATTRIBUTION OF ACTIONS WITHOUT UTILIZING PERSISTENT CLIENT-SIDE STORAGE OR CROSS-PROCESS COMMUNICATION

(71) Applicant: Tune, Inc., Seattle, WA (US)

(72) Inventor: Lucas Brown, Seattle, WA (US)

(73) Assignee: TUNE, INC., Seattle, WA (US)

(21) Appl. No.: 14/657,969

(22) Filed: Mar. 13, 2015

Related U.S. Application Data
(60) Provisional application No. 61/952,822, filed on Mar. 13, 2014.
(60) Provisional application No. 61/952,814, filed on Mar. 13, 2014.

(51) Int. Cl. G06Q 30/02; G06F 9/445

(52) U.S. Cl. CPC G06Q 30/0246; G06F 8/61

(57) ABSTRACT

Systems and methods for attributing actions on an end user computing device to an advertising publisher without using persistent storage or cross-process communication on the end user computing device are provided. In some embodiments, multiple types of credit for a single application installation may be provided to multiple advertising providers. Credit for attributed installs, install assists, and non-windowed install contributions may be provided. In some embodiments, credit may be adjusted after an initial processing of a conversion based on information received after the initial processing of the conversion, while still maintaining consistency in summary reports.

### CROSS-REFERENCES TO RELATED APPLICATIONS

This application claims the benefit of Provisional Application No. 61/952,822, filed Mar. 13, 2014, and Provisional Application No. 61/952,814, filed Mar. 13, 2014, the entire disclosures of which are hereby incorporated by reference herein for all purposes.

### BACKGROUND

Tracking technology may be used to track end user behavior for the purposes of providing compensation to third parties and/or providing analytics to advertisers. Such analytics may be used to target advertising and/or help determine the effectiveness of particular advertising campaigns, advertisement publishers, and/or advertising networks. If the subject matter of the advertisement is a software application, it is particularly useful to know if a user who clicked on the advertisement for the software application also downloaded and installed the software application. It is also useful to know how the end user uses the software application.

Unfortunately, currently available methods of tracking downloads, installations, and usage of a software application by a user of an end user computing device are technically inadequate. Some methods require the storage of a cookie on the device and/or using JavaScript code to interrogate the user's device. U.S. Patent Publication No. 2012/0278186 describes one such exemplary method. Technical difficulties arise when attempting to use such a method on an end user computing device such as an iPhone, an Android Phone, a Windows Phone, and/or other types of smartphones. For example, most such end user computing devices “sandbox” each application, thereby preventing applications from storing persistent data accessible to other applications on the same device. Many end user computing devices may also limit the execution of executable code such as JavaScript that is downloaded by a web browser or other advertisement displaying application.

While these limitations on accessing device functionality can improve the security and privacy of end user computing devices, they make it technically challenging for legitimate actors to track end user behavior. For example, a first application may be prevented from storing information about a clicked advertisement on the end user computing device in a way that a second application publicized in the advertisement and later installed or executed can access. Accordingly, tracking functionality included in the second application has no way of obtaining information from local storage regarding the advertisement that led to its install or execution.

Methods of tracking end user clicks and matching them to subsequent application installations (and usage) that avoid using cross-application or inter-process communication on the end user computing device and/or using executable code downloaded with an advertisement to interrogate the user's device are desirable. The present application provides these and other advantages as will be apparent from the following detailed description and accompanying figures.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a system for tracking installations of an application on end user computing devices that restrict inter-process communication and access to local storage is provided. The system comprises a tracking data store and a tracking server. The tracking data store is configured to store a plurality of click records and a plurality of install records. Each click record of the plurality of click records includes device identifying information, application identifying information, and a publisher identifier. Each install record of the plurality of install records includes device identifying information and application identifying information. The tracking server is configured to receive a first install notification from a first computing device, the first install notification including first device identifying information that identifies a computing device on which the application was installed and application identifying information that identifies the application, and to process a conversion for the application. The tracking server is configured to process the conversion for the application by searching the plurality of click records for a set of click records that match the first device identifying information and the application identifying information; and assigning a first type of credit to a first publisher identified in a click record of the set of click records for the installation of the application, or identifying the installation as an organic install if the set of click records is empty. The tracking server is also configured to, after processing the conversion, receive a new notification from a second computing device different from the first computing device, the new notification including the first device identifying information and the application identifying information that identifies the application; and use the new notification to modify credit assigned while processing the conversion.

In some embodiments, a computer-implemented method for attributing an installation of an application on an end user computing device that restricts inter-process communication and access to local storage is provided. A tracking server receives a first install notification from a first computing device, the first install notification including first device identifying information that identifies the end user computing device and application identifying information that identifies the application. The tracking server processes a conversion for the application, wherein processing the conversion for the application includes searching a plurality of click records for a set of click records that match the first device identifying information and the application identifying information; assigning a first type of credit for the installation of the application to a first publisher identified in a click record of the set of click records in response to determining that the set of click records is not empty; and identifying the installation as an organic install if the set of click records is empty. After processing the conversion, the tracking server receives a new notification from a second computing device different from the first computing device, the new notification including the first device identifying information and the application identifying information that identifies the application. The tracking server modifies credit assigned while processing the conversion using the new notification.

In some embodiments, a computer-readable medium having computer-executable instructions stored thereon is provided. The instructions, in response to execution by one or more processors of a tracking server, cause the tracking server to perform actions for attributing an installation of an application on an end user computing device that restricts inter-process communication and access to local storage. The tracking server receives a first install notification from a first computing device, the first install notification including first device identifying information that identifies the end user computing device and application identifying information that identifies the application. The tracking server processes a conversion for the application. Processing the conversion for the application includes searching a plurality of click records for a set of click records that match the first device identifying information and the application identifying information; assigning a first type of credit for the installation of the application to a first publisher identified in a click record of the set of click records in response to determining that the set of click records is not empty; and identifying the installation as an organic install if the set of click records is empty. After processing the conversion, the tracking server receives a new notification from a second computing device different from the first computing device, the new notification including the first device identifying information and the application identifying information that identifies the application; and the tracking server modifies credit assigned while processing the conversion using the new notification.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates an exemplary embodiment of a system configured to track advertisement selections and application installations according to various aspects of the present disclosure;

FIG. 2A is a block diagram that illustrates a first exemplary flow of information through a portion of the system of FIG. 1 according to various aspects of the present disclosure;

FIG. 2B is a block diagram that illustrates a second exemplary flow of information through a portion of the system of FIG. 1 according to various aspects of the present disclosure;

FIG. 2C is a block diagram that illustrates a third exemplary flow of information through a portion of the system of FIG. 1 according to various aspects of the present disclosure;

FIG. 2D is a block diagram that illustrates a fourth exemplary flow of information through a portion of the system of FIG. 1 according to various aspects of the present disclosure;

FIG. 3 is a flowchart that illustrates an exemplary method of creating an advertisement including a tracking link according to various aspects of the present disclosure;

FIG. 4 is a flowchart that illustrates an exemplary method of creating the tracking link according to various aspects of the present disclosure;

FIG. 5 is a flowchart that illustrates an exemplary method of distributing the advertisement including the tracking link according to various aspects of the present disclosure;

FIG. 6A is a flowchart that illustrates an exemplary method of selecting the advertisement and installing an application associated with the advertisement according to various aspects of the present disclosure;

FIG. 6B is a flowchart that illustrates an exemplary method of collecting device information when the advertisement is selected according to various aspects of the present disclosure;

FIG. 7A is a flowchart that illustrates an exemplary method in which an advertisement provider computing device either instructs an end user computing device to open the application associated with the advertisement, or redirects the end user computing device to an application provider from which the application may be downloaded and installed, according to various aspects of the present disclosure;

FIG. 7B is a flowchart that illustrates an exemplary method of recording a user click record according to various aspects of the present disclosure;

FIG. 8 is a flowchart that illustrates an exemplary method of collecting device information when the application associated with the advertisement is installed and matching at least a portion of the device information with the device information collected when the advertisement was selected according to various aspects of the present disclosure;

FIG. 9 is a flowchart that illustrates an exemplary method of sending a tracking identifier (and other information) to a tracking system when an in-application event occurs within the installed application according to various aspects of the present disclosure;

FIG. 10 is a flowchart that illustrates an exemplary method of storing the tracking identifier (and other information) sent to the tracking system when the in application event occurred within the installed application according to various aspects of the present disclosure;

FIG. 11A depicts an exemplary first management interface page configured to request a tracking link and provide the requested tracking link to a customer according to various aspects of the present disclosure;

FIG. 11B depicts an exemplary second management interface page configured to display reports according to various aspects of the present disclosure;

FIG. 12 is a schematic diagram of exemplary hardware and an exemplary operating environment in conjunction with which implementations of the computing devices and network of the system of FIGS. 1 and 2A-2D may be practiced according to various aspects of the present disclosure;

FIG. 13 is a timeline that illustrates various types of credit that may be assigned in some embodiments of the present disclosure;

FIGS. 14A-C are tables that illustrates three separate non-limiting examples of scenarios in which credit for attributed installs and install assists is assigned according to various aspects of the present disclosure;

FIGS. 15A-D are tables that illustrate three separate non-limiting examples of scenarios in which credit for attributed installs, install assists, and non-windowed install contributions is assigned according to various aspects of the present disclosure;

FIG. 16 is a drawing of an exemplary embodiment of an interface for presenting tracking information to a publisher according to various aspects of the present disclosure;

FIG. 17 is a flowchart that illustrates an exemplary embodiment of a method of attributing an application installation in view of information received post-conversion according to various aspects of the present disclosure;

FIG. 18 is a flowchart that illustrates an exemplary embodiment of a method for determining credit for re-attribution as appropriate according to various aspects of the present disclosure;

FIGS. 19A-19D illustrate how particular events would be attributed during post-conversion processing by some embodiments of the present disclosure;

FIGS. 20A-20D illustrate how other events would be attributed during post-conversion processing by some embodiments of the present disclosure;

FIGS. 21A-21D illustrate how additional events would be attributed during post-conversion processing by some embodiments of the present disclosure; and

FIGS. 22A-22D illustrate an example of how events may be attributed during post-conversion processing by particular embodiments of the present disclosure.

### DETAILED DESCRIPTION

Tracking System Overview

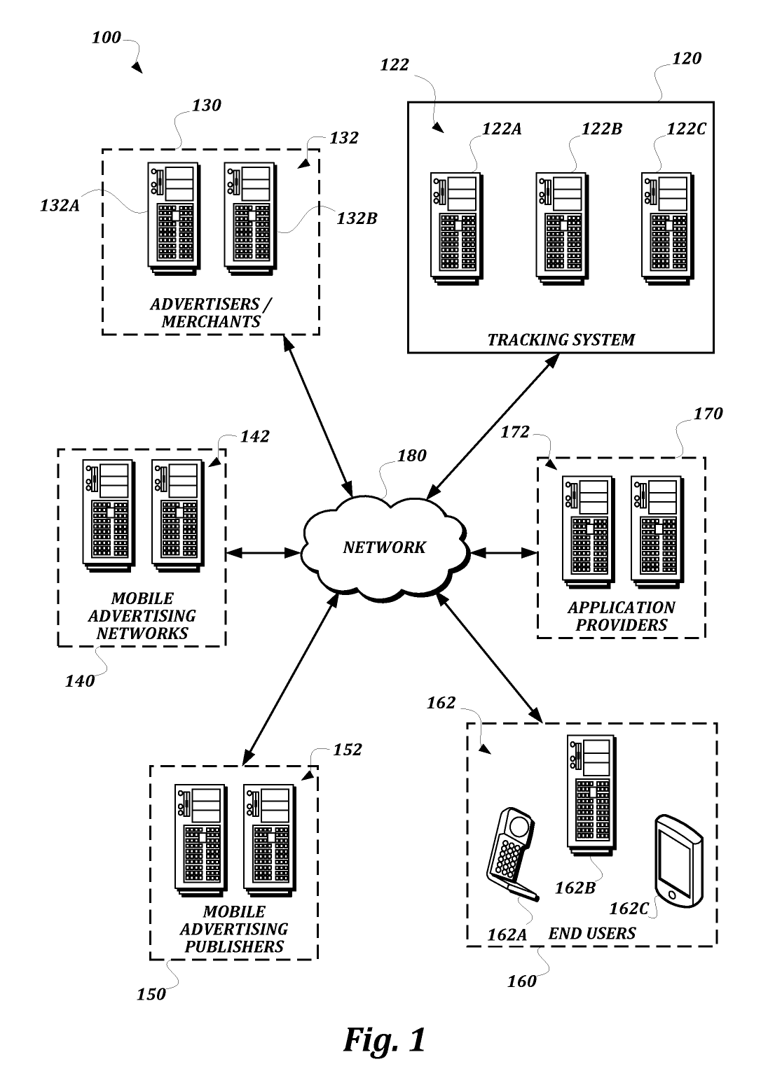

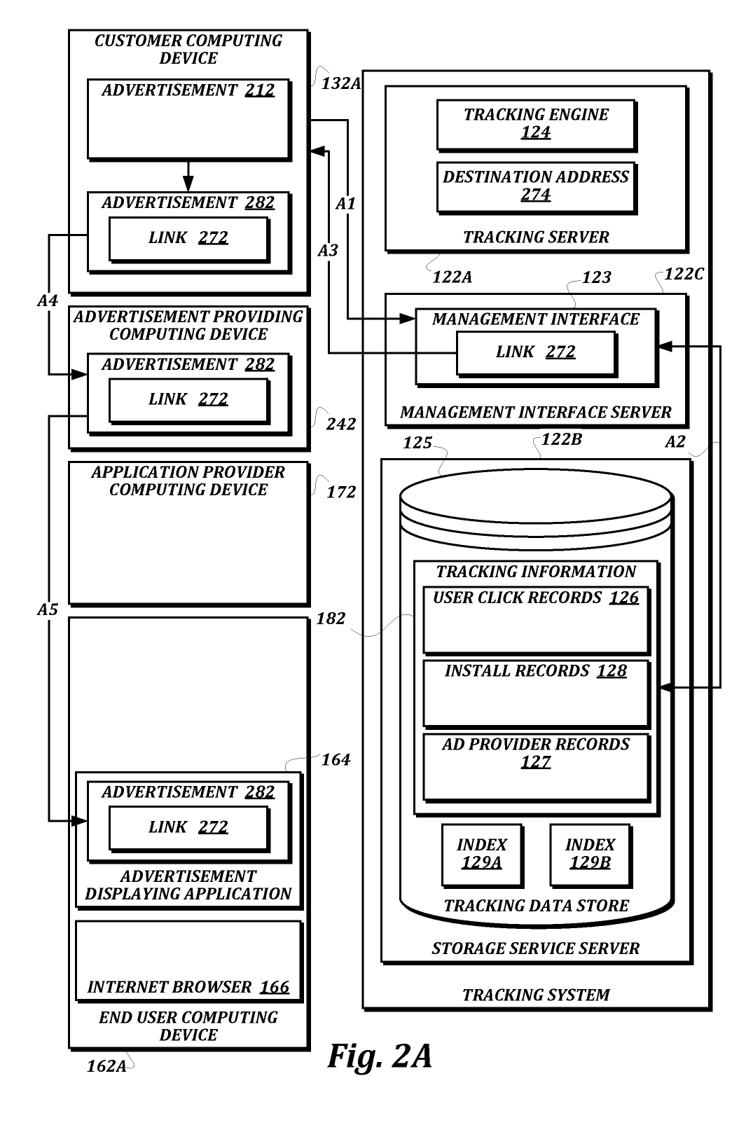

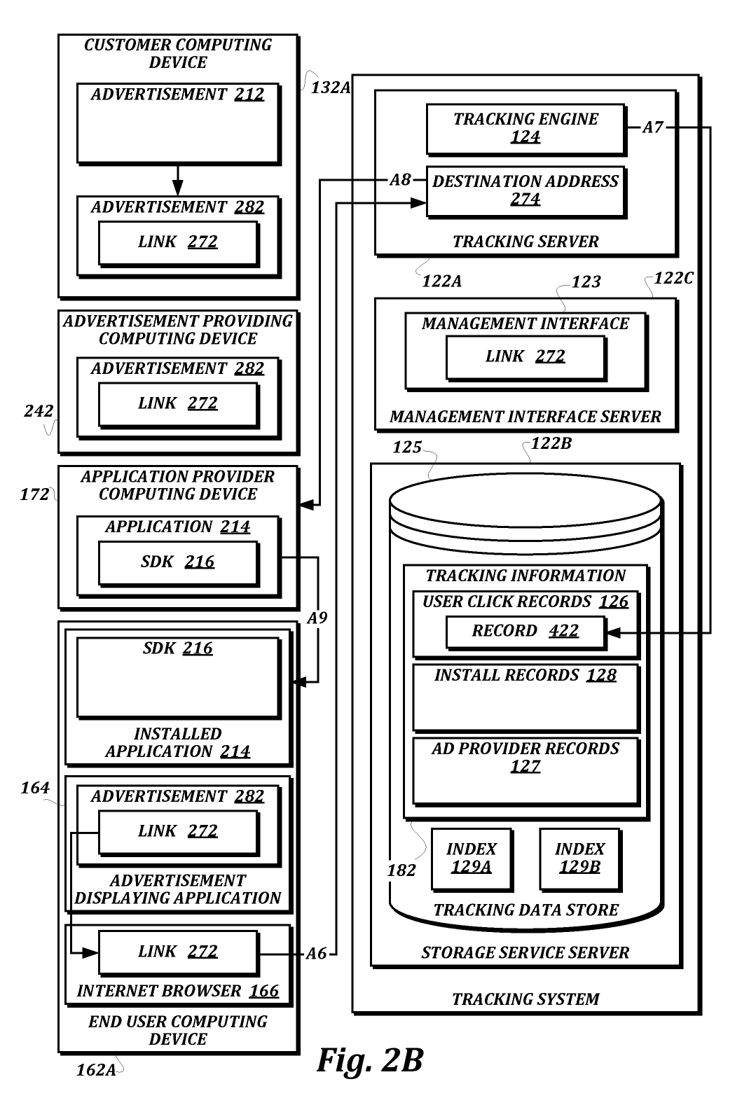

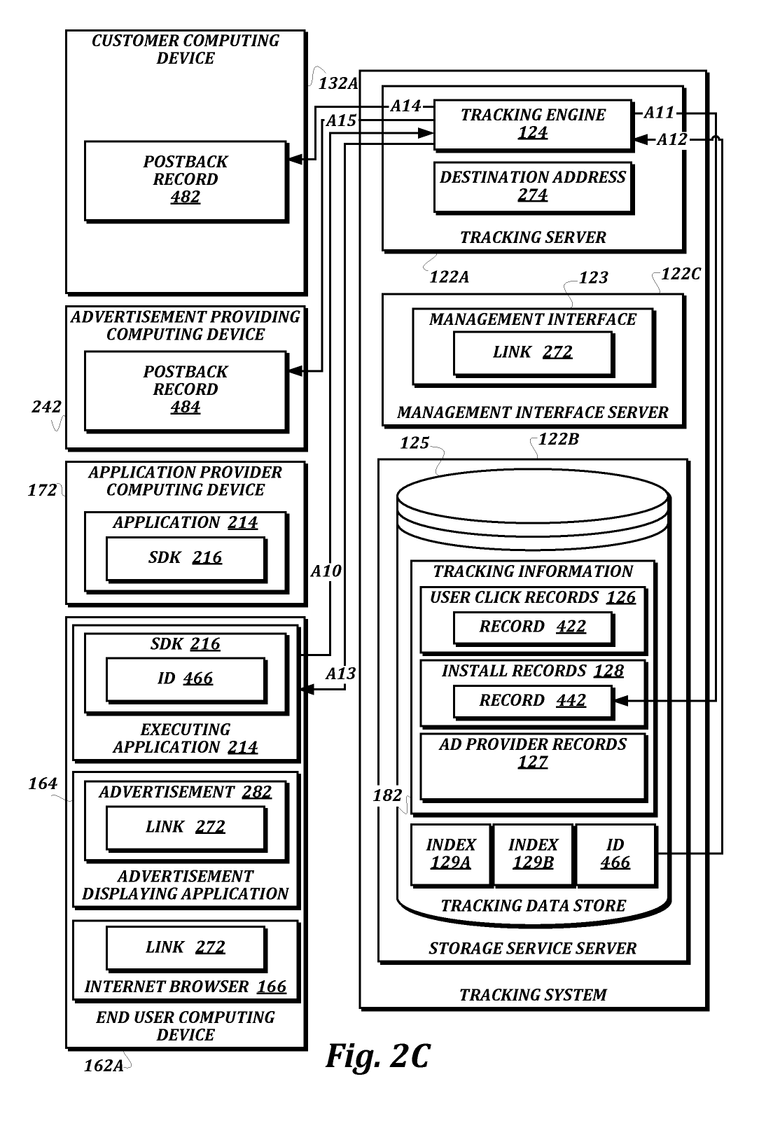

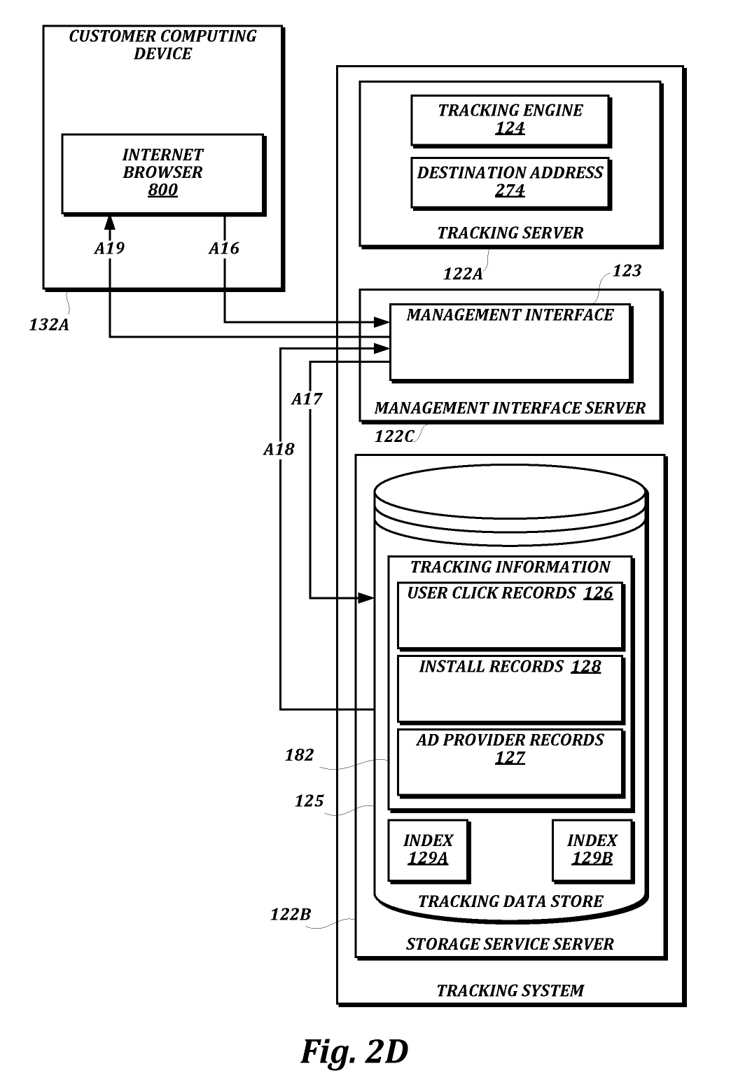

FIG. 1 is a block diagram that illustrates an exemplary embodiment of a system 100 configured to match interactions with (e.g., clicks on) advertisements with subsequent installations and usage of applications associated with the selected advertisements so that such actions may be attributed to the appropriate party or parties that provided (e.g., distributed and/or displayed) the selected advertisements to those who interacted with the advertisements and installed the applications, according to various aspects of the present disclosure. FIGS. 2A-2D are block diagrams that illustrate exemplary embodiments of information flow through portions of the system 100 according to various aspects of the present disclosure. One of ordinary skill in the art will note that the system 100 overcomes the technical challenge of attributing actions to parties who distributed and/or displayed advertisements without relying on cross-process or cross-application communication on the end user computing device.

Turning to FIG. 1, the system 100 includes a tracking system 120. The tracking system 120 includes one or more computing devices 122. In the embodiment illustrated, the computing devices 122 include a tracking server 122A, a storage service server 122B, and a management interface server 122C. In alternate embodiments, the computing devices 122 may include multiple tracking servers, multiple storage service servers, and/or multiple management interface servers. In some embodiments, the storage service server 122B is external to (and optionally remote from) the tracking system 120. In other embodiments, the functionality of the tracking server 122A and the storage service server 122B may be combined on a single computing device (not shown). In some embodiments, the functionality of the tracking server 122A and the management interface server 122C may be combined on a single computing device (not shown). The tracking system 120 is not limited to the use of a particular number of computing devices to implement the functionality of the tracking server 122A, the storage service server 122B, and the management interface server 122C.

Turning to FIG. 2A, the tracking server 122A is configured to provide a tracking engine 124 that communicates with the storage service server 122B. In general, the term “engine” as used herein refers to logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines or applications, or can be divided into sub-engines. The engines can be stored in any type of computer readable medium or computer storage device and be stored on and executed by one or more general purpose computers, thus creating a special purpose computer configured to provide the engine.

The storage service server 122B is configured to provide a tracking data store 125 that stores tracking information 182 received from the tracking server 122A and/or the management interface server 122C. The tracking information 182 includes a plurality of user click records 126, one or more application installation records 128, and one or more advertisement provider records 127. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

In some embodiments, each of the user click records 126 includes a site ID value (or a package name value) and device information. Similarly, each of the application installation records 128 includes a site ID value (or a package name value) and device information. The site ID value and the package name value each identify the application 214 for which advertising performance is being tracked (see FIG. 2B). The device information includes at least one device identifier and/or other information associated with one of the computing devices 162 (see FIG. 1). The device identifiers may be assigned to the computing devices 162 to uniquely identify the computing devices 162. Examples of device identifiers include, but are not limited to, a media access control (“MAC”) Address, an International Mobile Station Equipment Identity (“IMEI”), a Mobile Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), combinations thereof, and the like. By way of a non-limiting example, the IMEI may be an Android IMEI. By way of another non-limiting example, the MEID may be an Android MEID. The other information associated with one of the computing devices 162 (see FIG. 1) may include an Internet Protocol (“IP”) Address, browser information (e.g., browser type, browser version, etc.), combinations thereof, and the like. The other information may be usable to identify a computing device 162, though the other information may be less reliable for uniquely identifying a computing device 162 than the device identifiers. Optionally, all or a portion of the device information may be hashed instead of being stored directly in plain text in the tracking information 182.

The tracking engine 124 may use the tracking data store 125 to store the user click records 126, the application installation records 128, and/or the advertisement provider records 127. In some embodiments, the tracking data store 125 is configured to create indexes (e.g., indexes 129A and 129B). The index 129A indexes the device information in the user click records 126. The index 129B indexes tracking identifiers (discussed below).

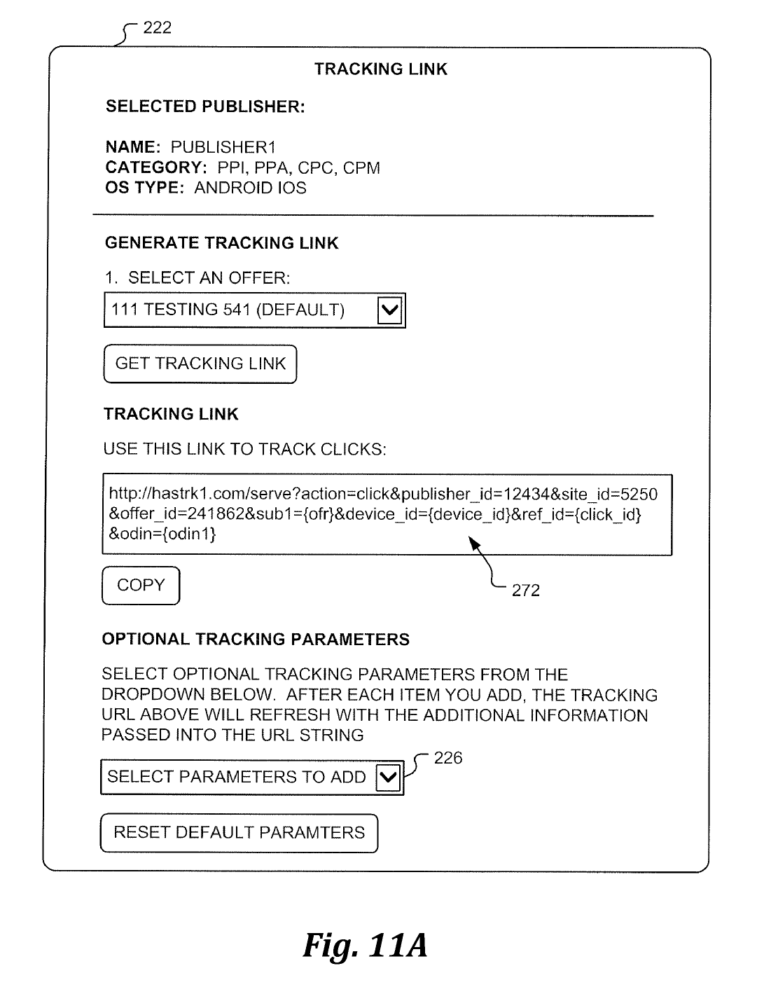

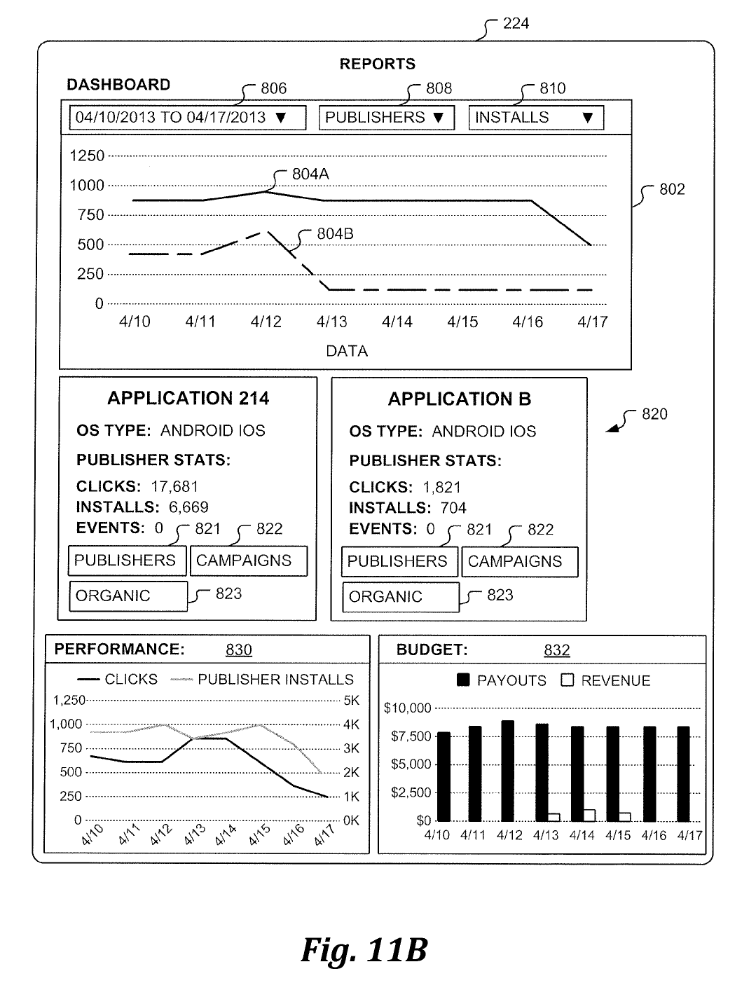

The management interface server 122C includes a management interface engine 123 configured to generate a management interface (e.g., a tracking link page 222 illustrated in FIG. 11A and a reports page 224 illustrated in FIG. 11B), described below. The management interface engine 123 is configured to access (e.g., via an Application Programming Interface (“API”)) the tracking information 182 stored in the tracking data store 125 and use the tracking information 182 to generate displays (e.g., graphs, charts, lists, reports, etc.) for the management interface.

The management interface engine 123 may include or communicate with web server components (not shown) configured to present conventional webpages displayable by conventional Internet browser applications executing on computing devices, such as a computing device 12 illustrated in FIG. 12 and described below. The management interface presented by the management interface engine 123 may include one or more web pages (e.g., the tracking link page 222 illustrated in FIG. 11A and the reports page 224 illustrated in FIG. 11B) that may be transmitted by the web server components (not shown) to other computing devices in the system 100 (see FIG. 1). Such web pages may be displayed by conventional Internet browser applications executing on the recipient computing devices.

Referring to FIG. 1, the system 100 includes one or more computing devices 132 operated by one or more Advertisers/Merchants 130, one or more computing devices 142 operated by one or more Mobile Advertising Networks 140, one or more computing devices 152 operated by one or more Mobile Advertising Publishers 150, a plurality of computing devices 162 operated by a plurality of End Users 160, and one or more computing devices 172 operated by one or more Application Providers 170.

As is apparent to those of ordinary skill in the art, a single entity may function as one of the Advertisers/Merchants 130, one of the Mobile Advertising Networks 140, and one of the Mobile Advertising Publishers 150. Such an entity may operate one or more computing devices (not shown) that perform the functions of the computing devices 132, 142, and 152.

The Advertisers/Merchants 130 include companies that wish to advertise products (e.g., software applications) and/or services. As is apparent to those of ordinary skill in the art, to receive some services, the computing devices 162 may be required to install one or more software applications.

The Mobile Advertising Networks 140 include companies that help distribute advertisements for the Advertisers/Merchants 130 for presentation to end users. The Mobile Advertising Networks 140 may provide services to Mobile Advertising Publishers 150 that allow Mobile Advertising Publishers 150 to present advertisements received from the Mobile Advertising Networks 140 to end users. Non-limiting examples of such companies include Google (the AdWords platform), Apple (the iAd platform), Millennial Media, Tapjoy, InMobi, Advertising.com, AdColony, Jumptap, Nexage, and the like.

The Mobile Advertising Publishers 150 include providers of web sites and mobile applications that display advertisements. Non-limiting examples of such companies include Pandora, Spotify, Facebook, Twitter, Bittorrent.com, The Weather Channel, and any other application or website provider that displays advertisements. In some embodiments, a company may act as both a Mobile Advertising Network 140 and a Mobile Advertising Publisher 150.

The End Users 160 include people who use the computing devices 162 and interact with advertisements, such as those created by the Advertisers/Merchants 130, distributed by the Mobile Advertising Networks 140, and/or displayed by the Mobile Advertising Publishers 150. The End Users 160 also use the computing devices 162 to purchase, download, install, and/or interact with applications provided by the Application Providers 170.

The Application Providers 170 include companies that provide installable applications (such as those advertised by the Advertisers/Merchants 130) to the End Users 160. Non-limiting examples of such companies include “app stores,” such as iTunes App Store, Google Play, Amazon Appstore, and the like. The one or more computing devices 172 may be configured to generate a download page (not shown) from which an application may be purchased, downloaded, and/or installed. The download page may be implemented as a webpage.

The computing devices 122, 132, 142, 152, 162, and 172 are connected to one another by a network 180 (e.g., the Internet). Each of the computing devices 122, 132, 142, 152, 162, and 172 may be implemented using a computing device similar to the computing device 12 illustrated in FIG. 12 and described below. By way of non-limiting examples, the computing devices 162 have been illustrated as including a cellular telephone or smartphone 162A, a personal computer 162B (e.g., a desktop computer), and a tablet computer 162C. Each of the computing devices 162 may be configured to implement an advertisement displaying application 164 (see FIGS. 2A-2C), such as an Internet browser application 166 (see FIGS. 2A-2C), and/or a different application configured to display advertisements. In some embodiments (such as the exemplary embodiment illustrated in FIGS. 2A-2C), the advertisement displaying application 164 is depicted as being different from the Internet browser application 166. However, this is not a requirement. In some embodiments, the advertisement displaying application 164 is the Internet browser application 166.

### Tracking Advertising Interactions and Application Installs

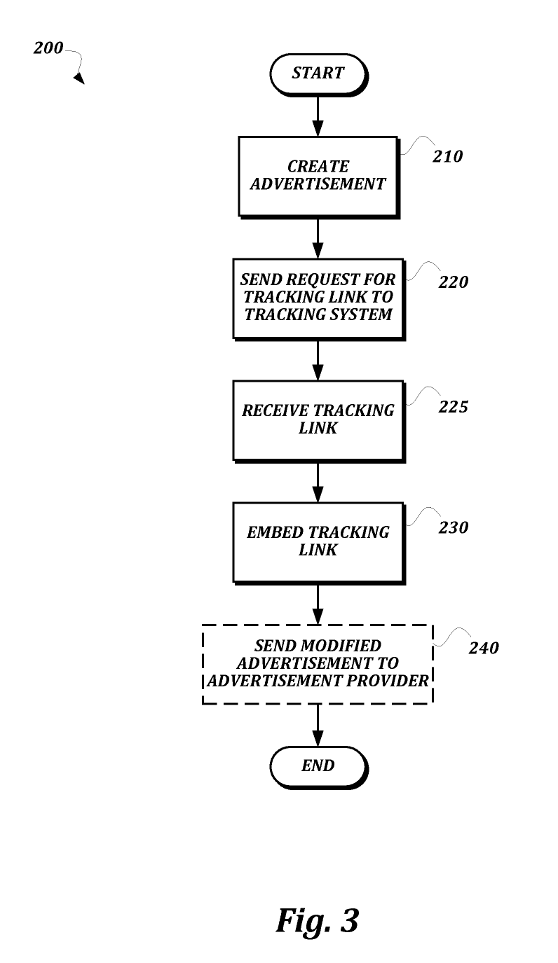

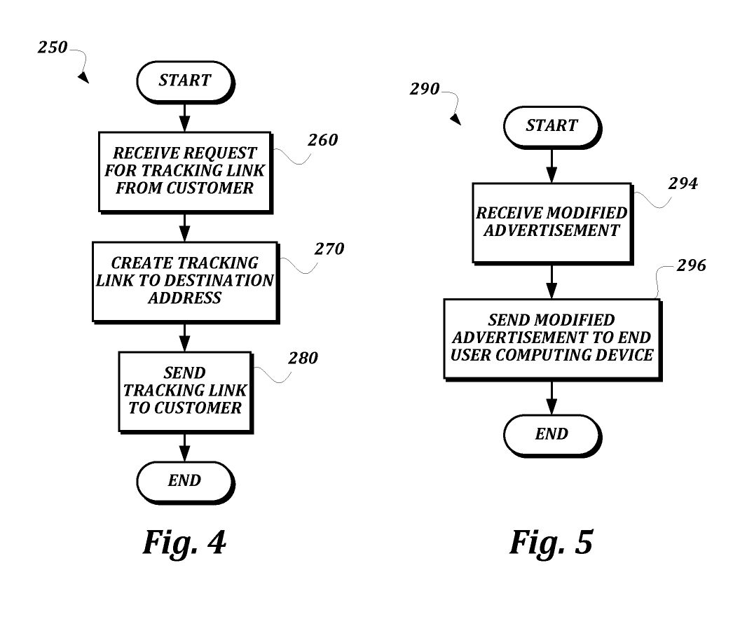

FIGS. 3 and 4 are flowcharts that illustrate exemplary embodiments of methods 200 and 250, respectively. The method 200 is performed by one or more computing devices operated by a customer. Referring to FIG. 1, the customer may be one or more of the Advertisers/Merchants 130, the Mobile Advertising Networks 140, and the Mobile Advertising Publishers 150. Thus, the method 200 may be performed by one or more of the computing devices 132, 142, and/or 152. For ease of illustration, the method 200 will be described as being performed by the computing device 132A operated by one of the Advertisers/Merchants 130, who in this example, is referred to as the customer.

Turning to FIG. 4, the method 250 is performed by the tracking system 120 (see FIG. 1). For ease of illustration, the method 250 will be described as being performed by the management interface engine 123 (see FIG. 2A).

Turning to FIG. 3, from a start block, the method 200 proceeds to block 210, where the customer creates an advertisement 212 (see FIG. 2A) for display to one or more of the End Users 160 by one or more of the plurality of computing devices 162. Turning to FIG. 2A, the advertisement 212 is configured to be displayed by the advertisement displaying application 164 (e.g., the Internet browser application 166 or the separate advertisement displaying application 164) executing on one or more of the plurality of computing devices 162 (e.g., the computing device 162A). The advertisement 212 is associated with an installable application 214 (see FIG. 2B) available for download on one of the computing devices 172 (see FIG. 2B).

In the embodiment illustrated in FIG. 2B, the application 214 includes a tracking Software Development Kit (“SDK”) 216 that includes functions and/or procedures that execute when selected events occur on the computing device (e.g., the computing device 162A) on which the application 214 is installed. For example, the tracking SDK 216 may include computer-executable instructions that execute when the application 214 is installed and used for the first time. By way of a non-limiting example, the tracking SDK 216 may be implemented as a library file that is included in an application project used to create the application 214. An application developer may specify which particular functions are called from the library to indicate to the tracking engine 124 when install events and/or other in-application (“in-app”) events have occurred. The tracking SDK 216 may include a package name value that identifies the application 214. The tracking SDK 216 is described and illustrated herein to represent code within the application 214 that communicates with the tracking engine 124. While some embodiments may incorporate a library that includes executable code provided by the tracking system directly into the application 214, in other embodiments, the application developer may access the described functionality by including calls to functions provided by a service of the tracking system (instead of executing code locally as part of the application 214). Though the tracking SDK 216 is primarily described herein as executing code within the application 214 for ease of discussion, one of ordinary skill in the art will recognize that such description also applies to embodiments wherein the application 214 accesses similar functionality provided by the tracking engine 124 over the network.

Returning to FIG. 2A, the advertisement 212 is accessible by the customer computing device 132A. In FIG. 2A, the advertisement 212 is stored on the customer computing device 132A. However, this is not a requirement.

Returning to FIG. 3, at block 220, the computing device 132A sends a request for a tracking link 272 to the management interface engine 123 via the network 180. In FIG. 2A, this is illustrated by arrow “A1.” By way of a non-limiting example, the management interface may include the tracking link page 222 (see FIG. 11A) into which the customer enters information and requests the tracking link 272. When the customer submits the tracking link page 222, the request is submitted to the management interface engine 123.

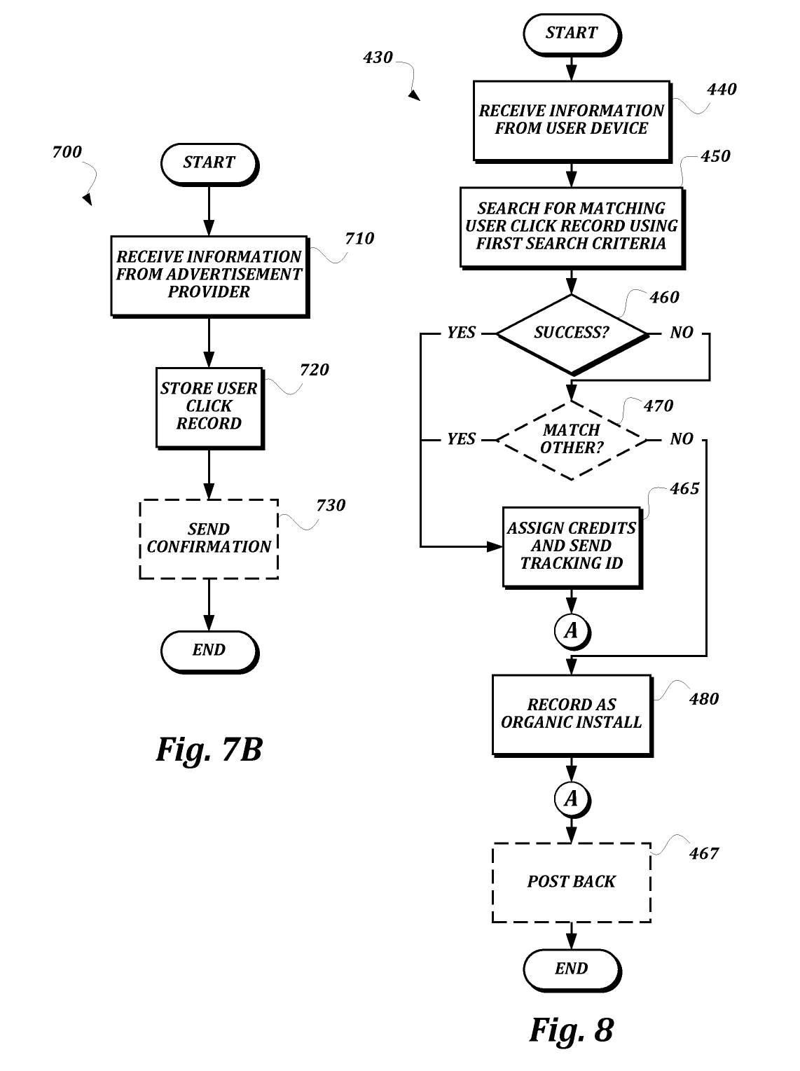

Turning to FIG. 4, at block 260 of the method 250 the management interface engine 123 receives the request for the tracking link 272 from the customer. At block 270, the management interface engine 123 creates the tracking link 272 to a destination address 274. In the embodiment illustrated in FIG. 2B, the destination address 274 is an address on the tracking server 122A. In embodiments in which methods 600 and 700 (see FIGS. 7A and 7B) are performed, the destination address 274 is an address on an advertisement providing computing device 242 (described below). The management interface engine 123 may store information (e.g., a campaign ID value (or an offer ID value), a publisher ID value, a site ID value, and/or the like) in the tracking data store 125. Further, the management interface engine 123 may use the information (e.g., the campaign ID value (or the offer ID value), the publisher ID value, the site ID value, and/or the like) stored in the tracking data store 125 to create the tracking link 272 in block 270. The transfer of information between the management interface engine 123 and the tracking data store 125 is illustrated by double-headed arrow “A2.”

In some embodiments, the campaign ID value or the offer ID value identifies an advertising campaign, and may be used to track the effectiveness of a particular campaign. In some embodiments, the publisher ID value identifies an advertisement provider (e.g., one or more of the Advertisers/Merchants 130, the Mobile Advertising Networks 140, and/or the Mobile Advertising Publishers 150) that operates the advertisement providing computing device 242 (see FIG. 2A). The advertisement provider is described in more detail below.

The tracking link 272 may be implemented as a uniform resource locator (“URL”). The customer can request that the tracking link 272 contain various pieces of information, such as a redirect link, one or more macros (e.g., macros that obtain device information (such as the MAC Address, Android ID, IFA, and/or the like), and/or other pieces of information e.g., the publisher ID, campaign ID, etc.). The destination address 274 and/or the tracking link 272 may be associated with an indicia, such as the site ID and/or the campaign ID. Any or all of these values may be hashed and the hash value included in the tracking link 272 instead of the values themselves.

As mentioned above, the tracking link 272 may include the redirect link. The redirect link may be implemented as an HTTP redirect that sends the end user computing device 162A to a third-party web page or an application provider web site (e.g., an app store) to obtain the application 214. The tracking link 272 may include the indicia and/or the address to which to redirect the computing devices 162. The tracking data store 125 may associate the tracking link 272 with information provided by the customer so the customer may use the tracking information to generate reports using the management interface (e.g., the reports page 224 illustrated in FIG. 11B) generated by the management interface engine 123. For example, the customer may have entered a publisher payout amount that may be used to generate a report that shows publisher payout amounts as compared to revenue earned.

The tracking link page 222 (FIG. 11A) illustrates an example of the tracking link 272. In this example, the tracking link 272 is:
http://hastrk1.com/serve?action=click&publisher_id=12434&site_id=5250&offer_id=241862&sub1={ofr}&device_id={device_id}&ref_id={click_id}&odin={odin1}

In this link, the destination address 274 (see FIG. 2B) is “http://hastrk1.com/serve.” The publisher ID is set equal to the value “12434,” which identifies the advertisement provider (e.g., one of the Mobile Advertising Publishers 150). The site ID is set equal to the value “5250,” which identifies the application 214. The offer ID is set equal to the value “241862,” which identifies the advertising campaign. Thus, the information stored in the tracking link 272 associates the advertisement with the advertisement provider (e.g., one of the Mobile Advertising Publishers 150), the application 214, and the advertising campaign.

As shown in FIG. 11A, the customer may include additional information in the tracking link 272 by using a user input 226 (e.g., a dropdown box) to select additional parameters. When a parameter is selected using the user input 226, the tracking link 272 is automatically modified to include the parameter and, if appropriate, a value assigned to the parameter.

In embodiments in which the methods 600 and 700 (see FIGS. 7A and 7B, respectively) are performed, the destination address 274 is to an address on the advertisement providing computing device 242. In such embodiments, the redirect address may be omitted.

In block 280, the management interface engine 123 sends the tracking link 272 to the customer computing device 132A via the network 180. In FIG. 2A, this is illustrated by arrow “A3.” By way of a non-limiting example, the management interface engine 123 may include the tracking link 272 in the tracking link page 222 illustrated in FIG. 11A, which may be displayed in a conventional Internet browser and from which the tracking link 272 can be copied and pasted (e.g., into the advertisement 212) by the customer. Then, the method 250 terminates.

Returning to FIG. 3, in block 225, the customer computing device 132A receives the tracking link 272. Optionally, referring to FIG. 2A, the customer may modify the tracking link 272 to include one or more macros that execute after one of the End Users 160 has interacted with (e.g. clicked) the advertisement 214. The macros may cause the end user computing device 162A to dynamically replace the macros with the device information (e.g., at least one device identifier and/or other information) associated with the end user computing device 162A. Further, the tracking link 272 may be modified to include other data, such as identifiers associated with the customer and/or other parties involved with distributing (e.g., one of the Mobile Advertising Networks 140) or displaying (e.g., one of the Mobile Advertising Publishers 150) the advertisement 212 to one of the End Users 160.

In block 230 shown in FIG. 3, referring to FIG. 2A, the customer computing device 132A embeds the tracking link 272 in the advertisement 212 to create a modified advertisement 282. At this point, the modified advertisement 282 is ready to be sent (e.g., pushed) to one or more of the end user computing devices 162.

In optional block 240 shown in FIG. 3, referring to FIG. 2A, the customer computing device 132A sends the modified advertisement 282 to the advertisement providing computing device 242 via the network 180. In FIG. 2A, this is illustrated by arrow “A4.” The advertisement providing computing device 242 is operated by the advertisement provider, which may include one or more of the Advertisers/Merchants 130, the Mobile Advertising Networks 140, and/or the Mobile Advertising Publishers 150. Thus, the advertisement providing computing device 242 may be one or more of the computing devices 132, 142, and/or 152. The advertisement provider may be the same as or different from the customer. In embodiments in which the advertisement provider is the same as the customer, optional block 240 may be omitted.

Then, the method 200 proceeds to an end block and terminates.

FIG. 5 is a flow diagram of a method 290 performed by the advertisement providing computing device 242 (see FIG. 2A) operated by the advertisement provider, which (as mentioned above) may include one or more of the Advertisers/Merchants 130, the Mobile Advertising Networks 140, and/or the Mobile Advertising Publishers 150.

In block 294, the advertisement providing computing device 242 receives the modified advertisement 282 from the customer computing device 132A. In embodiments in which the advertisement provider is the same as the customer, block 294 may be omitted.

Then, in block 296, the advertisement providing computing device 242 (e.g., one of the computing devices 152) sends (e.g., pushes) the modified advertisement 282 to one or more of the plurality of computing devices 162 via the network 180. For ease of illustration, in FIG. 2A, the modified advertisement 282 is pushed to the end user computing device 162A, as illustrated by arrow “A5.” Then, the method 290 terminates.

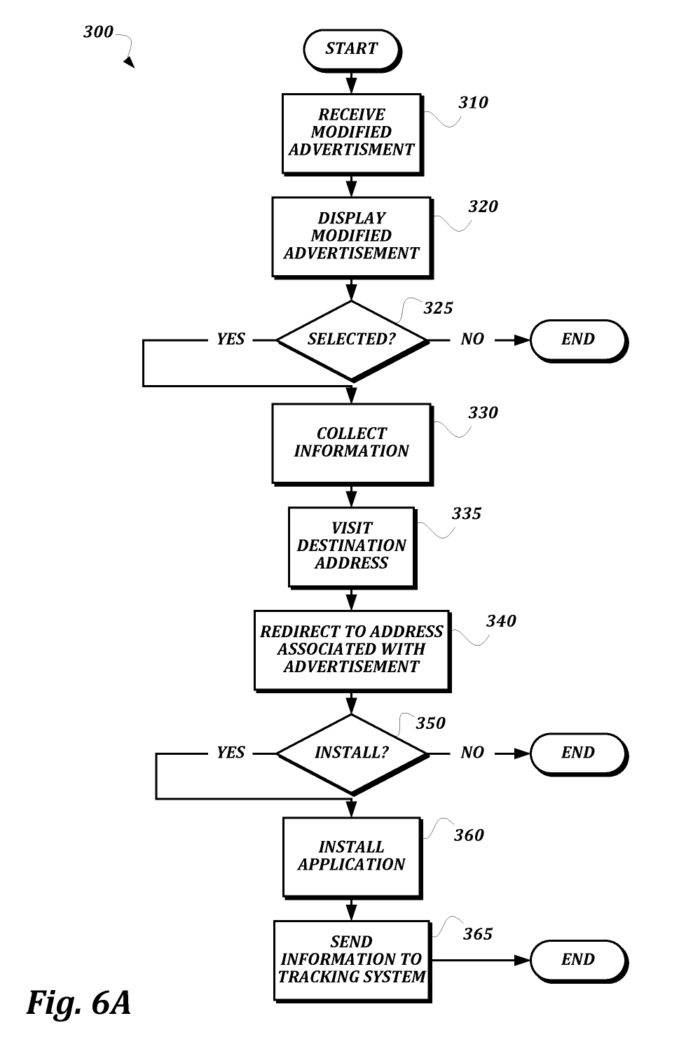

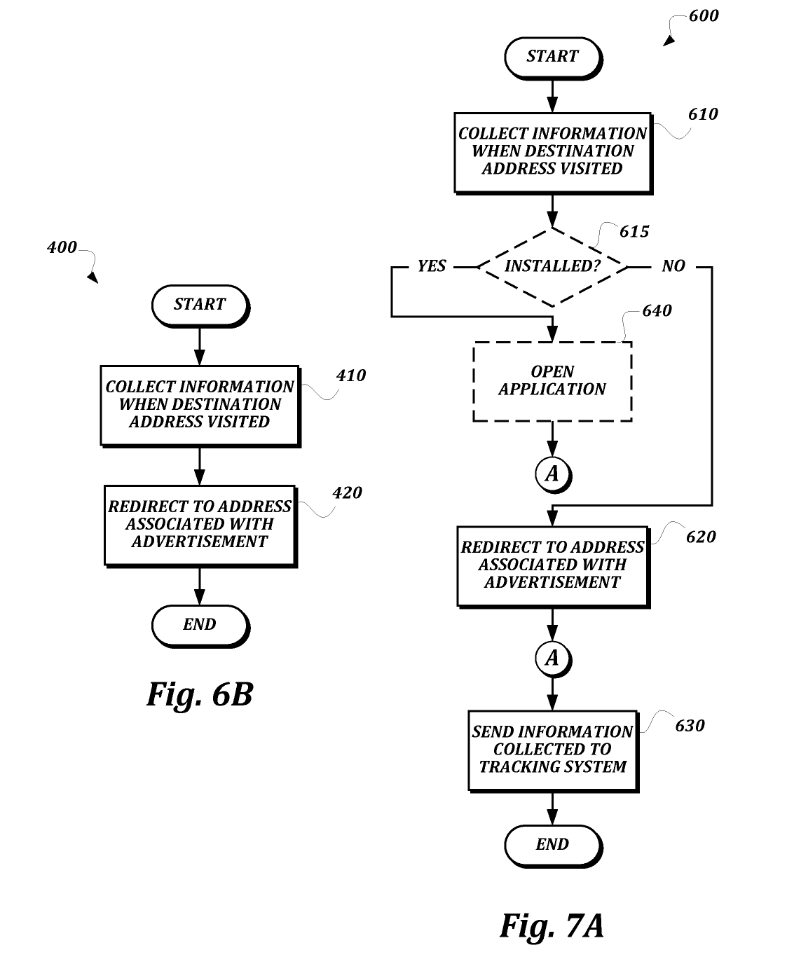

FIGS. 6A and 6B are flow diagrams of methods 300 and 400, respectively. The method 300 is performed by one of the computing devices 162 operated by the end Users 160. Thus, the method 300 may be performed by one or more of the computing devices 162A, 162B, or 162C. For ease of illustration, the method 300 will be described as being performed by the end user computing device 162A. The method 400 is performed by the tracking system 120. For ease of discussion, the method 400 will be described as being performed by the tracking engine 124 executing on the tracking server 122A. However, as is apparent to those of ordinary skill in the art, portions of the method 400 may be performed by the tracking data store 125 (see FIGS. 2A-2D) and/or the tracking engine 124 working together with the tracking data store 125.

Turning to FIG. 6A, from a start block, the method 300 proceeds to block 310, where the end user computing device 162A receives the modified advertisement 282 pushed to the end user computing device 162A by the advertisement providing computing device 242. At block 320, the advertisement displaying application 164 (see FIG. 2B) executing on the end user computing device 162A displays the modified advertisement 282 to the end user operating the end user computing device 162A.

The end user may interact with (e.g., tap or click on) the modified advertisement 282 using a user interface of the end user computing device 162A. When this occurs, the end user computing device 162A receives the user selection via the user interface.

In decision block 325, the end user computing device 162A determines whether the end user has selected or otherwise interacted with the modified advertisement 282. The decision in decision block 325 is “YES” when the end user has selected or otherwise interacted with the modified advertisement 282. On the other hand, the decision in decision block 325 is “NO” if the end user does not interact with the modified advertisement 282.

When the decision in decision block 325 is “NO,” the method 300 proceeds to an end block and terminates. When the decision in decision block 325 is “YES,” the method 300 proceeds to block 330, where the end user computing device 162A collects the device information (e.g., the IFA, the Android ID, the MAC address, the IP address, browser information, and/or the like) associated with the end user computing device 162A, and stores that information in the tracking link 272. As mentioned above, the tracking link 272 may include macros that instruct the end user computing device 162A to collect the device information associated with the end user computing device 162A, and store that information in the tracking link 272. In some embodiments, the advertisement displaying application 164 may collect the information about the end user computing device 162A.

Next, at block 335, the tracking link 272 causes the computing device 162A to visit the destination address 274 (which, in this example, is on the tracking server 122A). In FIG. 2B, this is illustrated by arrow “A6.” In the embodiment illustrated, the tracking link 272 causes the end user computing device 162A to use the Internet browser application 166 to visit the destination address 274. In such embodiments, the Internet browser application 166 may collect the information about the end user computing device 162A. In some embodiments, the device information may be transmitted as part of a message body of an HTTP POST request, instead of (or in addition to) being transmitted as part of the tracking link 272.

Turning to FIG. 6B, from a start block, the method 400 proceeds to block 410, where the tracking engine 124 executing on the tracking server 122A collects the information stored in the tracking link 272 and/or obtains information from the HTTP header or message body received by the tracking server 122A. For example, the HTTP header may include the IP address and browser information for the end user computing device 162A by default. The tracking engine 124 stores the information received in the tracking link 272 and/or obtained from the HTTP header or message body as a user click record 422 (see FIG. 2B) in the user click records 126 stored in the tracking data store 125. In FIG. 2B, this is illustrated by arrow “A7.” By way of a non-limiting example, the device information associated with the end user computing device 162A stored in the user click record 422 may include the user's MAC address, IP address, and browser information. In some embodiments, the user click record 422 may also include a timestamp or other indicator of when the click or other interaction with the link 272 occurred.

The tracking engine 124 may also credit the appropriate party or parties (e.g., the advertisement provider associated with the advertisement providing computing device 242) for the user click. The party or parties credited may be identified in the tracking link 272. By way of a non-limiting example, a “credit” may be stored in the tracking information 182 stored on the storage service server 122B. For example, the advertisement provider records 127 may be updated to reflect the “credit” earned by the advertisement provider associated with the advertisement providing computing device 242. In some embodiments, the tracking engine 124 may include an identifier of the advertisement provider in the user click record 422, or may otherwise associate the user click record 422 with the advertisement provider, so that further analysis with respect to clicks generated by the advertisement provider may be performed later.

As mentioned above, the tracking link 272 may include the indicia associated with the address (and/or the address itself) to which to redirect the end user computing devices 162. The address is an address of one of the Application Providers 170 from which the installable application 214 may be purchased, downloaded, and/or installed. At block 420 in FIG. 6B, the tracking engine 124 redirects the end user computing device 162A to the address whereat the installable application 214 may be purchased, downloaded, and/or installed. In FIG. 2B, this is illustrated by arrow “A8.” By way of a non-limiting example, in block 420, the tracking engine 124 may issue an HTTP redirect to the Internet browser application 166 to direct the Internet browser application 166 to the application provider computing device 172. The method 400 then proceeds to an end block and terminates.

Returning to FIG. 6A, after the method 400 has been performed and the end user computing device 162A has been redirected to the address associated with the advertisement as illustrated at block 340, the end user may decide to install the application 214. However, this decision need not be made immediately following the redirect and could be made at a much later time, or not in response to following the redirect.

In decision block 350, the computing device 162A determines whether the end user has decided to install the application 214. The decision in decision block 350 is “YES” when the end user has decided to install the application 214 and to execute it for the first time. The end user may use the user interface of the end user computing device 162A to indicate to the end user computing device 162A that the end user wishes to install and use the application 214. On the other hand, the decision in decision block 350 is “NO” if the end user decides not to install the application 214.

When the decision in decision block 350 is “NO,” the method 300 terminates. When the decision in decision block 350 is “YES,” the method 300 proceeds to block 360, where the end user computing device 162A downloads and installs the application 214. In FIG. 2B, this is illustrated by arrow “A9.” The end user may use the user interface of the end user computing device 162A to purchase, download, and/or install the application 214 in block 360. When this occurs, the end user computing device 162A receives user instructions via the user interface and in response thereto, downloads and installs the application 214.

As mentioned above, the application 214 includes the tracking SDK 216. When the installed application 214 is first used, the method 300 proceeds to block 365, where the tracking SDK 216 causes the end user computing device 162A to automatically obtain device information associated with the end user computing device 162A and send that information to the tracking engine 124 (e.g., with a “log” request). In FIG. 2C, this is illustrated by arrow “A10.” By way of a non-limiting example, the tracking SDK 216 may include one or more functions that the application developer executes from within the application 214 when one or more selected events occurs (e.g., the application is installed or executed for the first time). For example, in block 365, the tracking SDK 216 may collect the device information associated with the end user computing device 162A, and send an HTTP request to the tracking server 122A that includes the information collected. As another example, an operating system of the end user computing device 162A may provide operations for obtaining such data, and the application 214 may insert the data into a request transmitted to a function provided by the tracking engine 124 (in embodiments wherein the functionality of the tracking SDK 216 is accessed by transmitting requests across the network). The request may optionally include the package name value (or another value) that identifies the installed application 214. Block 365 may occur in the background of the end user computing device 162A and may not alter the end user's visual experience with the executing application 214. The method 300 then proceeds to an end block and terminates.

While the method 300 and the arrows of FIG. 2B illustrate an embodiment wherein the application installation is initiated on the same end user computing device 162A as presented the advertisement, in some embodiments, multiple end user computing devices 162 may be involved in the transaction. For example, an end user may use a desktop computing device to interact with an advertisement which then directs the end user to an app store. The end user may use the desktop computing device to purchase the application, which is then installed on the mobile end user computing device 162A via a cloud download, via a sync process, or via any other suitable technique. In such embodiments, the click record generated by the desktop computing device and the install performed on the mobile end user computing device 162A may be associated by a user identifier, by a mobile device identifier known to the desktop computing device, or by any other suitable technique.

In alternate embodiments, when the method 300 (see FIG. 6A) is performed, the methods 600 and 700 (see FIGS. 7A and 7B, respectively) may be performed instead of the method 400 illustrated in FIG. 6B. FIGS. 7A and 7B are flowcharts that illustrate exemplary embodiments of the methods 600 and 700, respectively. The methods 600 and 700 are performed when the destination address is on the advertisement providing computing device 242 (instead of on the tracking server 122A). These methods may be characterized as enabling loading tracking links server-side. When the methods 600 and 700 are performed, the end user computing device 162A does not visit the tracking server 122A before being redirected to one of the application provider computing devices 172. Instead, the advertisement providing computing device 242 redirects the computing device 162A to one of the application provider computing devices 172.

The method 600 is performed by the advertisement providing computing device 242. The method 700 is performed by the tracking system 120. For ease of illustration, the method 700 will be described as being performed by the tracking engine 124 executing on the tracking server 122A. However, as is apparent to those of ordinary skill in the art, portions of the method 700 may be performed by the tracking data store 125 (see FIGS. 2A-2D) and/or the tracking engine 124 working together with the tracking data store 125.

The method 600 illustrated in FIG. 7A begins after the end user computing device 162A visits a destination address on the advertisement providing computing device 242 in block 335 of the method 300 illustrated in FIG. 6A. From a start block, the method 600 proceeds to block 610, where the advertisement providing computing device 242 collects the information stored in the tracking link 272 and/or obtains information from the HTTP header or message body received by the advertisement providing computing device 242.

In optional decision block 615, the advertisement providing computing device 242 determines whether the application 214 is already installed on the end user computing device 162A. By way of a non-limiting example, the advertisement providing computing device 242 may store or have access to records tracking which applications have been installed by at least some of the end user computing devices 162. For example, the advertisement providing computing device 242 may query the tracking data store 125 via the management interface engine 123 to determine whether the application 214 is already installed on the end user computing device 162A.

The decision in optional decision block 615 is “YES” when the advertisement providing computing device 242 determines the application 214 is installed on the end user computing device 162A. On the other hand, the decision in optional decision block 615 is “NO” when the advertisement providing computing device 242 determines the application 214 is not installed on the end user computing device 162A.

When the decision in optional decision block 615 is “NO,” or the optional decision block 615 has been omitted, the method 600 advances to block 620. At block 620, the advertisement providing computing device 242 redirects the end user computing device 162A to the address whereat the installable application 214 may be purchased, downloaded, and/or installed. By way of a non-limiting example, in block 620, the advertisement providing computing device 242 may issue an HTTP redirect to the Internet browser application 166. After block 620, the advertisement providing computing device 242 advances to a continuation terminal (“terminal A”), and block 340 of the method 300 illustrated in FIG. 6A may be performed by the end user computing device 162A.

Returning to FIG. 7A, when the decision in optional decision block 615 is “YES,” the advertisement providing computing device 242 advances to optional block 640. In optional block 640, the advertisement providing computing device 242 directs the end user computing device 162A to open the application 214. Conventional methods of directing the application displaying application 164 (e.g., the Internet browser application 166) to open the application 214 may be used in optional block 640. After optional block 640, the advertisement providing computing device 242 advances to a continuation terminal (“terminal A”). In embodiments in which the optional block 640 has been omitted, when the decision in optional decision block 615 is “YES,” the advertisement providing computing device 242 advances to terminal A.

From terminal A, the method 600 proceeds to block 630, where the advertisement providing computing device 242 sends at least a portion of the information collected in block 610 to the tracking system 120 (e.g., the tracking server 122A) so the tracking system 120 may record a user click record. Then, the method 600 proceeds to an end block and terminates.

Turning to FIG. 7B, the method 700 proceeds from a start block to block 710, where the tracking engine 124 receives the information sent by the advertisement providing computing device 242 in block 630 of the method 600 illustrated in FIG. 7A.

Returning to FIG. 7B, in block 720, the tracking engine 124 stores at least a portion of the information received in block 710 in the user click records 126 stored in the tracking data store 125. Similar to the discussion above with respect to block 410 of FIG. 6B, a user click record 422 is created and credit may be provided to an appropriate party or parties. By way of a non-limiting example, the information received in block 710, and stored in the user click record 422 (see FIG. 2B) may include the site ID value, user's MAC address value, IP address value, browser information, and a timestamp.

The tracking engine 124 may also credit the appropriate party or parties (e.g., the advertisement provider associated with the advertisement providing computing device 242) for the user click. The party or parties credited may be identified in the information received in block 710. By way of a non-limiting example, a “credit” may be stored in the tracking information 182 stored on the storage service server 122B. For example, the advertisement provider records 127 may be updated to reflect the “credit” earned by the advertisement provider associated with the advertisement providing computing device 242. In some embodiments, the tracking engine 124 may include an identifier of the advertisement provider in the user click record 422, or may otherwise associate the user click record 422 with the advertisement provider, so that further analysis with respect to clicks generated by the advertisement provider may be performed later.

Then, in optional block 730, the tracking engine 124 may send a confirmation or acknowledgement to the advertisement providing computing device 242 indicating that the tracking engine 124 received the information sent by the advertisement providing computing device 242 in block 630 of the method 600 illustrated in FIG. 7A. In the embodiment illustrated, block 720 is performed before block 730. In alternate embodiments, block 730 may be performed before block 720. Then, the method 700 proceeds to an end block and terminates.

FIG. 8 is a flowchart that illustrates an exemplary embodiment of a method 430 performed by the tracking system 120 for assigning credits for tracked installations according to various aspects of the present disclosure. For ease of illustration, the method 430 will be described as being performed by the tracking engine 124 executing on the tracking server 122A. However, as is apparent to those of ordinary skill in the art, portions of the method 430 may be performed by the tracking data store 125 (see FIGS. 2A-2D) and/or the tracking engine 124 working together with the tracking data store 125.

Turning to FIG. 8, from a start block, the method 430 proceeds to block 440, where the tracking engine 124 receives the information sent by the tracking SDK 216 in block 365 of the method 300 illustrated in FIG. 6A. The information received may be stored in an application installation record 442 in the application installation records 128 depicted in FIG. 2C. This information transfer and storage is illustrated in FIG. 2C by the arrow labeled “A11.”

Returning to FIG. 8, in block 450, the tracking engine 124 attempts to match the application installation record 442 with the information previously stored in one of the user click records 126 using first search criteria. For example, the first search criteria may specify that the device identifier (such as an IFA value and/or the like) and the site ID values between the user click record 126 and the application installation record 442 must match. The first search criteria may also include a predetermined “lookback” period (e.g., seven days). In this example, if the tracking engine 124 received the IFA value “703122b3-c066-40fc-859f-d5a8d4373c6c” and a particular site ID value from the tracking SDK 216 (in block 440), in block 450 the tracking engine 124 will attempt to find a user click record in the user click records 126 that includes the same IFA and site ID values. For ease of illustration, the user click record 422 includes the IFA value “703122b3-c066-40fc-859f-d5a8d4373c6c,” and the particular site ID value. In this example, the tracking engine 124 would locate the user click record 422 because it includes the IFA value “703122b3-c066-40fc-859f-d5a8d4373c6c,” and the particular site ID value. Then, the tracking engine 124 determines whether the user click record 422 was created within the predetermined lookback period. If the user click record 422 was created within the predetermined lookback period, the tracking engine 124 has successfully located a matching click record. If the user click record 422 was not created within the predetermined lookback period, the tracking engine 124 has failed to locate a matching click record.

By way of another non-limiting example, the first search criteria may specify that the IFA values and the package name values must match. In such embodiments, the package name value is used instead of the site ID value.

In decision block 460, the tracking engine 124 determines whether the search conducted in block 450 using the first search criteria was successful. The decision in decision block 460 is “YES” when the search conducted in block 450 was successful. For example, the decision in decision block 460 is “YES” when the tracking engine 124 locates a matching user click record created within the predetermined lookback period. On the other hand, the decision in decision block 460 is “NO” when the search conducted in block 450 was unsuccessful, or did not find a user click record created within the predetermined lookback period that matches the first search criteria.

When the decision in decision block 460 is “YES,” the method proceeds to block 465, where the tracking engine 124 assigns credit for a conversion (from a click to an install) to the advertisement 212 (see FIG. 2A) and advertisement provider (identified in the tracking link 272 and stored in the user click record 422) that led to the installation. The tracking engine 124 may store this information in the tracking information 182 stored in the tracking data store 125. For example, in some embodiments, the advertisement provider records 127 may be updated to reflect the “credit” earned by the advertisement provider associated with the advertisement providing computing device 242. In some embodiments, a financial incentive may be provided to the advertisement provider in the form of a payment transfer to an account of the advertisement provider at a financial institution, a credit to an account of the advertisement provider as tracked by the tracking system, and/or the like. In some embodiments, credit may be assigned for a conversion via method 430 dynamically during a query for attribution information from the tracking data store 125.

Optionally, the tracking data store 125 generates a tracking identifier 466 and sends the tracking identifier 466 to the tracking engine 124. In FIG. 2C, this is illustrated by arrow “A12.” Then, the tracking engine 124 sends the tracking identifier 466 (see FIG. 2C) to the tracking SDK 216. In FIG. 2C, this is illustrated by arrow “A13.” From block 465, the method 430 proceeds to a continuation terminal (“terminal A”).

When the decision in decision block 460 is “NO,” the tracking engine 124 may advance to optional decision block 470. In embodiments in which optional decision block 470 is omitted, the tracking engine 124 advances directly from block 460 to block 480.

In optional decision block 470, the tracking engine 124 tries to locate a matching user click record (for the application installation record 442) using different second search criteria than that used in block 450. For example, the tracking engine 124 may try to match the site ID (or the package name) and a device fingerprint (such as one or more of an IP address, device brand, device model values, and/or the like) received from the tracking SDK 216 (in block 440) with information stored in the user click records 126. The second search criteria may also include a predetermined lookback period (e.g., twenty-four hours). The predetermined lookback period of the second search criteria may be the same as the predetermined lookback period of the first search criteria, or may be different.

The decision in optional decision block 470 is “YES” when the tracking engine 124 locates a user click record using the second search criteria. For example, the decision in optional decision block 470 is “YES” when the tracking engine 124 locates a matching user click record created within the predetermined lookback period. When the decision in optional decision block 470 is “YES,” the tracking engine 124 advances to block 465 to assign credit to the entities associated with the user click record as described above. On the other hand, the decision in optional decision block 470 is “NO” when the tracking engine 124 fails to locate a user click record using the second search criteria. When the decision in optional decision block 470 is “NO,” the method 430 proceeds to block 480.

At block 480, the tracking engine 124 records the installation as an “organic install” (e.g., in the tracking information 182 stored on the storage service server 122B) to indicate that the installation occurred without matching a user click record. Then, the method 430 advances to a continuation terminal (“terminal A”).

From terminal A, the method 430 may advance to optional block 467. In embodiments that omit the optional block 467, the method 430 proceeds to an end block and terminates from terminal A.

In optional block 467, the tracking engine 124 may send a “server postback” to one or more of the Advertisers/Merchants 130, the Mobile Advertising Networks 140, and/or the Mobile Advertising Publishers 150 that includes the information recorded on the tracking server 122A and/or the storage service server 122B. For example, the server postback may include the information stored in the application installation record 442 and matching user click record 422. In FIG. 2C, arrow “A14” depicts server postback 482 to the customer, and arrow “A15” depicts server postback 484 to the advertisement provider. Each of the server postbacks 482 and 484 provides a copy of at least a portion of the information recorded on the tracking server 122A and/or the storage service server 122B that the recipient can use for a variety of purposes. Then, the method 430 proceeds to an end block and terminates.

To make searching and matching more efficient, the device information associated with the computing devices 162 (e.g., the IP address values, IFA values, Open UDID values, and the like) may be indexed (e.g., the index 129B) by the tracking data store 125. The tracking engine 124 may use the index 129B when searching for a match in block 450 and/or optional decision block 470.

In-App Tracking and Re-Engagement

As mentioned above, the application developer may specify that particular functions and/or procedures within the tracking SDK 216 are executed whenever one or more selected application events occur. Non-limiting examples of in-app events include level-ups, in-app purchases, user interactions with interface elements, account creations, and/or the like. In some embodiments, credit may be provided to advertisement providers 150 for driving re-engagement with the application that causes such in-app events to occur. Tracking and providing such credit may be useful when the end user installed the application 214 several months ago, and the application provider 170 would like provide compensation to advertisement providers 150 for getting the end user to reopen the application 214 and complete an action or event, such as an in-app purchase. Thus, those advertisement providers 150 who cause end users to re-engage with the application 214 receive credits for such re-engagement. Re-engagement may be particularly useful for applications that are typically used infrequently.

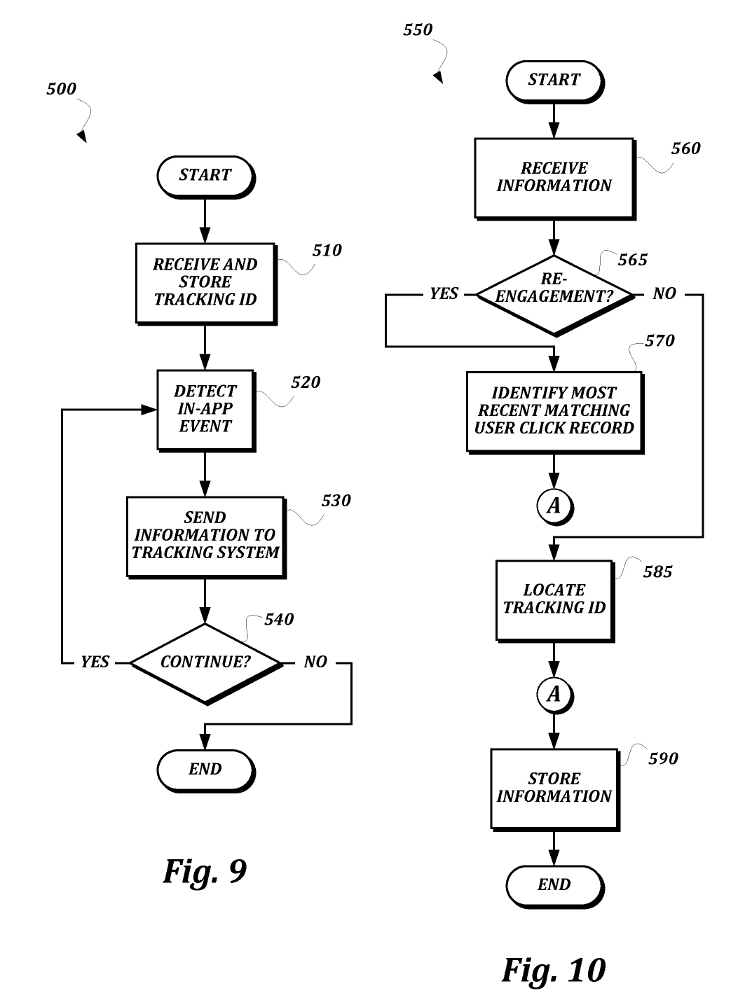

FIG. 9 is a flowchart that illustrates an exemplary embodiment of a method 500 performed by one of the end user computing devices 162 according to various aspects of the present disclosure. For ease of illustration, the method 500 will be described as being performed by the end user computing device 162A.

From a start block, the method 500 proceeds to block 510, where the tracking SDK 216 executing on the computing device 162A receives the tracking identifier 466 (see FIG. 2C) via the network 180 from the tracking engine 124 executing on the tracking server 122A. The tracking SDK 216 stores the tracking identifier 466 for subsequent use.

In block 520, the tracking SDK 216 detects an in-app event has occurred. In block 530, the tracking SDK 216 sends information to the tracking server 122A upon the detection of the application event. The information includes at least the tracking identifier 466. In some embodiments, the information may also include a purchase price or other revenue information if the tracked in-app event was a purchase or other revenue generating event. In some embodiments, the information may also include an indication of whether re-engagement has been enabled for the tracked in-app event. In some embodiments, the information may include the site ID value or the package name value (to identify the application 214) and the device information that may be used to locate a matching user click record stored for the computing device 162A and the application 214. In some embodiments, the information may also include a description or identification of a particular in-app event that occurred. In each of these embodiments, the application developer may cause the additional information to be included with the tracking identifier 466 when sent to the tracking server 122A. In some embodiments, the tracking SDK 216 may identify whether or not re-engagement has been enabled, instead of receiving an indication of such enablement as part of the information.

In decision block 540, the tracking SDK 216 determines whether to continue monitoring for the occurrence of in-app events. The decision in decision block 540 is “YES,” when the tracking SDK 216 decides to continue monitoring for the occurrence of in-app events. On the other hand, decision in decision block 540 is “NO,” when the tracking SDK 216 decides not to continue monitoring for the occurrence of in-app events. By way of a non-limiting example, the decision in decision block 540 is “YES” as long as the application 212 is executing. Otherwise, the decision in decision block 540 is “NO.”

When the decision in decision block 540 is “YES,” the tracking SDK 216 returns to block 520. On the other hand, when the decision in decision block 540 is “NO,” the method 500 proceeds to an end block and terminates.

FIG. 10 is a flowchart that illustrates an exemplary embodiment of a method 550 performed by the tracking system 120 for assigning credit for in-app events according to various aspects of the present disclosure. For ease of illustration, the method 500 will be described as being performed by the tracking engine 124 executing on the tracking server 122A.

From a start block, the method 550 proceeds to block 560, where the tracking engine 124 receives the information sent by the tracking SDK 216, as described in block 530 of the method 500 illustrated in FIG. 9 and discussed above. The information includes at least the tracking identifier 466 (see FIG. 2C).

In decision block 565, the tracking engine 124 determines whether re-engagement has been enabled in association with the event being reported by the information received. If re-engagement is not enabled, the in-app event indicated by the information received is attributed (or credited) to the same entity or entities who received credit for the installation of the application 214 as discussed above and as indicated in the tracking data store 125. On the other hand, if re-engagement is enabled, the in-app event indicated by the information received may be credited to one or more advertisement providers who recently interacted with the end user. An indication of whether re-engagement has been enabled may be included in the information received in block 560.

The decision in decision block 565 is “YES” when re-engagement has been enabled. On the other hand, the decision in decision block 565 is “NO” when re-engagement has not been enabled. When the decision in decision block 565 is “NO,” the method 550 advances to block 585. At block 585, the tracking engine 124 uses the tracking identifier 466 (and optionally the index 129B) to identify the application installation record 442 associated with the computing device 162A and the application 212, and the user click record 422 (or records) matched with the application installation record 442. The method 550 then proceeds to a continuation terminal (“terminal A”).

When the decision in decision block 565 is “YES,” the method 550 advances to block 570. At block 570, the tracking engine 124 matches the information received in block 560 with the information previously stored in one or more of the user click records 126. For example, the tracking software 124 may search for matching user click records using a third search criteria similar to the first search criteria or second search criteria discussed above (e.g., matching device identifier and site ID values, matching device fingerprint and site ID values, and/or the like). The method 550 then proceeds to a continuation terminal (“terminal A”).

From terminal A, the method 550 proceeds to block 590, where the tracking engine 124 stores the information received in block 560 and associates it with the application installation record 442 and the matching user click records 422. The tracking engine 124 may store this information in the tracking information 182 stored in the tracking data store 125. For example, in some embodiments, the advertisement provider records 127 may be updated to reflect the “credit” earned by the advertisement provider associated with the advertisement providing computing device 242. In some embodiments, a financial incentive may be provided to the advertisement provider in the form of a payment transfer to an account of the advertisement provider at a financial institution, a credit to an account of the advertisement provider as tracked by the tracking system, and/or the like. In some embodiments, credit may be assigned for a re-engagement via method 550 dynamically during a query for attribution information from the tracking data store 125.

Then, the method 550 proceeds to an end block and terminates.

Providing Credit to More than One Advertisement Provider

In some embodiments, if more than one match is located in block 450, optional decision block 470, and/or block 570, the tracking engine 124 may assign credit to the matching user click record that occurred most recently before the tracked install or in-app action. While the tracking and assignation of credit to a most recent user click record before the action can provide a useful metric, this metric may not capture the entirety of what has actually happened to generate that action. Often a user may be influenced by or interact with a multitude of publishers' advertising efforts before finally installing a given mobile app or re-engaging with the given mobile app after installation. To help provide richer information, some embodiments of the present disclosure may be configurable to assign credit based on more than one matching user click record for a single application action such as installation or re-engagement. Further, some embodiments of the present disclosure may be configurable to assign different types of credit, such as credit for action assists and for non-windowed action contributions, to multiple parties for a given action. These metrics can provide a customer with insight into (and therefore help the customer understand) the full impact of a publisher with regard to acquiring new users and encouraging users to interact with the application after installation.

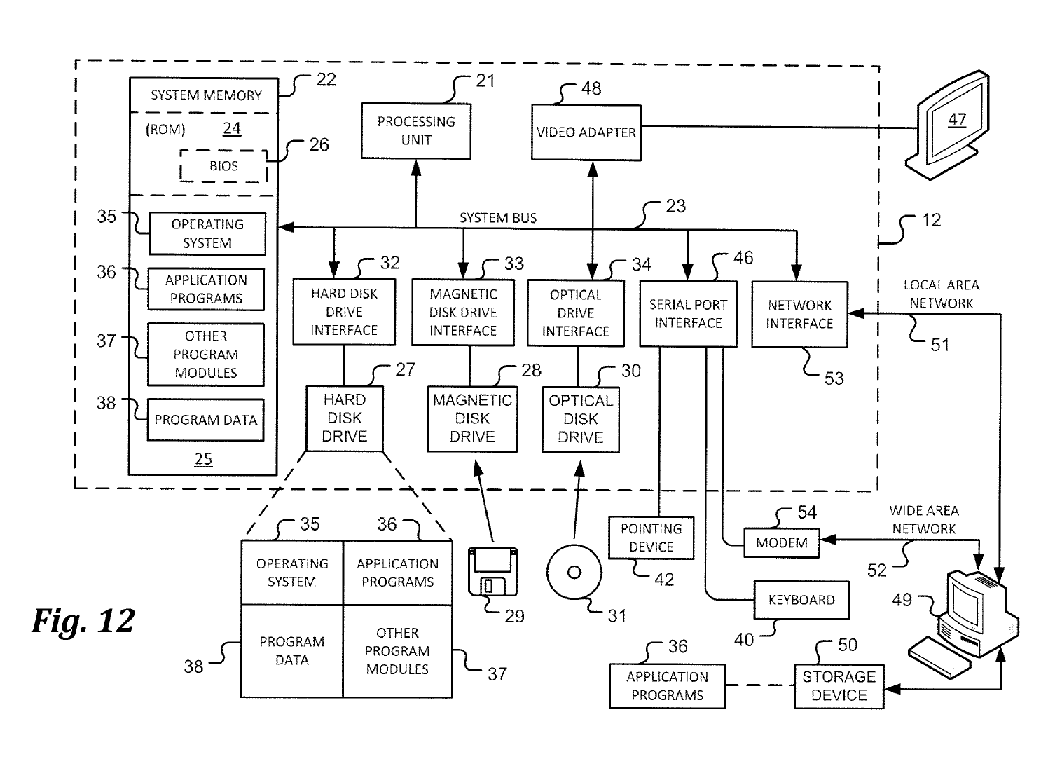

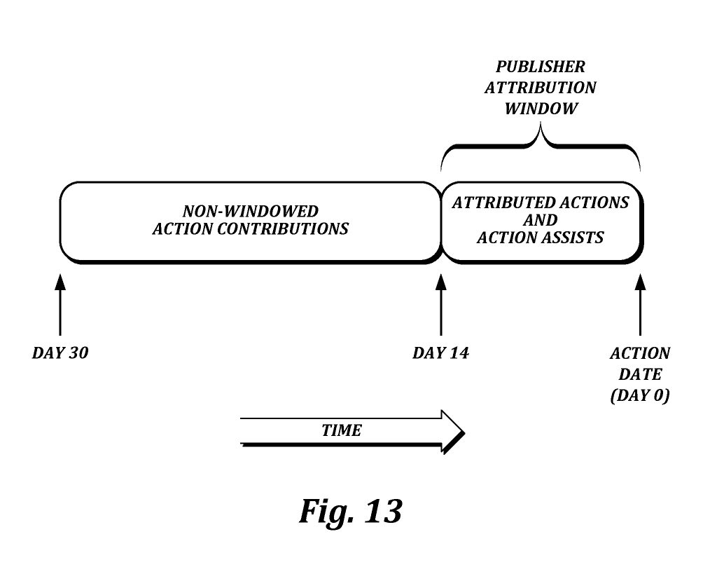

The install attribution method illustrated above in FIG. 8 and the accompanying text primarily discusses a last-click model for ease of discussion. That is, the ad provider associated with the last matching click before the install is given credit for the install. Such credit may be referred to as an “attributed install” credit. FIG. 13 is a timeline that illustrates various other types of credit that may be assigned in some embodiments of the present disclosure. The timeline illustrates assigning credit as either an “attributed action,” an “action assist,” or a “non-windowed action contribution.” The “action” associated with the credit may be either an “install” or a “re-engagement,” as discussed above. In some embodiments, when credit is being assigned for an install, the credit may be referred to as an “attributed install,” an “install assist,” or a “non-windowed install contribution.” Likewise, in some embodiments, when credit is being assigned for a re-engagement, the credit may be referred to as an “attributed re-engagement,” a “re-engagement assist,” or a “non-windowed re-engagement contribution.” Because the handling of credit for installs and re-engagements are similar, the timeline of FIG. 13 and some of the text below refers to “attributed actions,” “action assists,” and “non-windowed action contributions” for ease of discussion. One of ordinary skill in the art will recognize that the techniques described with respect to “attributed actions,” “action assists,” and non-windowed action contributions” are applicable to providing credit for installs, re-engagement, or any other tracked actions.

In the timeline illustrated in FIG. 13, a tracked action (e.g., an installation or a re-engagement event) occurs at Day Zero on the right side of the diagram. The timeline extends back to the left to show an extent of time in the past before the tracked action. In some embodiments, credit for an “action assist” may be granted to an additional ad provider that is associated with a matching click other than the last matching click before the action. In the embodiment illustrated in the timeline, a publisher attribution window of 14 days is established. Within 14 days of the action date, the closest matching click record to the action date will be given the credit for an attributed action, while other matching click records that were earlier than the action date but within the publisher attribution window (i.e., not longer than 14 days earlier than the action date) will be given credit for action assists.

In the embodiment illustrated in the timeline of FIG. 13, a contribution window of 30 days is also established. The “contribution window” is similar to the “lookback” period described above, in that the matching criteria may match clicks for an action that occurred within the contribution window, and may not match clicks that preceded the action date by more than the contribution window. In some embodiments, credit may be provided for non-windowed action contributions as well as attributed actions and action assists. Credit for a “non-windowed action contribution” may be provided to an ad provider associated with a matching click that was later than the contribution window, but occurred before the attribution window. Clicks that occur before the contribution window may either not be considered matching clicks, or may simply not be granted any credit even if they are determined to be matching clicks. In some embodiments, the contribution window may be set to an infinite value or otherwise ignored, such that matching clicks outside of the attribution window are given credit for non-windowed action contributions no matter how long before the action they occurred.

The timeline in FIG. 13 is associated with a given ad provider, a given search criteria, and a given action. For example, the timeline may be associated with “Publisher One,” and may apply to clicks that match an action based on a device identifier. In some embodiments, the tracking system 120 may allow a customer to configure different attribution windows for different publishers, and/or for different search criteria. For example, a different timeline may be associated with “Publisher Two,” which may include a seven day attribution window instead of the fourteen day window illustrated in FIG. 13. As another example, an additional timeline may be associated with “Publisher One,” wherein a five day attribution window is applied for matching clicks that are matched using search criteria that include matching an action based on a device fingerprint instead of a device identifier. A customer may wish to configure a shorter attribution window to comply with a publisher policy, to compensate for greater uncertainty in match criteria, and/or for any other suitable reason.

In some embodiments, the contribution window may be configurable by the customer, but may apply to all ad providers and all search criteria. In some embodiments, the contribution window may be configurable on a finer-grained basis, such as applying to a set of ad providers, and a customer may configure a first contribution window for a first set of ad providers and a second contribution window for a second set of ad providers. The tracking system 120 may establish a maximum contribution window based on capabilities of the system, based on tuning to increase a signal-to-noise ratio with regard to the usefulness of the collected data, or based on any other suitable criteria. A customer may then configure a contribution window to be applied that is shorter than the maximum contribution length.

One of ordinary skill in the art will also recognize that, in some embodiments, the contribution window and attribution window settings may be separately configurable for different actions. As a non-limiting example, a customer may establish a first attribution window for a first ad provider for installs, and a second attribution window for the first ad provider for re-engagement.

The tracking of action assists and/or non-windowed action contributions can provide many advantages to customers in analyzing the effectiveness of advertising. As an example of an advantage, action assists can provide insight into duplicate rates and overlap between publishers. If a first publisher has little overlap with other publishers and therefore has unique traffic, then they will likely have a low number of action assists and non-windowed action contributions compared to attributed actions. The first publisher could be considered particularly valuable to the customer if the number of attributed actions is high. Likewise, if a second publisher has a high number of action assists or non-windowed action contributions compared to attributed actions, then the second publisher is providing advertising to end users that are also being presented advertising from other sources that is also driving actions. A customer might then use this information to consider moving advertising from the second publisher to other publishers in order to consolidate advertising spending, to provide more business to publishers that are closer to the last click, and/or for other purposes.

As another example of an advantage, the action assist metric allows customers to measure performance of ad providers that drive product awareness, instead of only allowing measurement of performance for ad providers that drive the last click before the action is tracked. This may be particularly useful if a customer is using a multitude of ad providers to concurrently provide advertising for a given application. Ad providers that are focused on awareness by providing banner ads, video ads, and/or the like can be highly effective in encouraging users to install and engage with an application at a later point in time, even if they do not immediately install or interact with the application upon clicking the advertisement. The performance of such ad providers will be captured via a high number of action assists and/or non-windowed action contributions, even if a number of attributed actions is low. Accordingly, customers can obtain insight into the performance of ad providers with varying purposes (such as driving awareness vs. driving installs or re-engagement), and can evaluate how each set of ad providers is performing with respect to their differing goals. If only attributed actions were to be tracked, such analysis would not be possible.

Further advantages for comparing ad provider performance are provided by use of the non-windowed action contribution metric. As discussed above different ad providers may be configured to use attribution windows of different lengths. In such embodiments, it may be difficult to compare performance for attributed actions and action assists for these ad providers in an apples-to-apples manner because the click totals will be based on different amounts of time. The tracking of non-windowed action contributions helps to address this issue. For example, a first publisher may have an attribution length of 14 days, and a second publisher with an attribution length of 28 days. A tracking system 120 may count 100 combined attributed installs and install assists for the first publisher, and 150 combined attributed installs and install assists for the second publisher. While the raw totals suggest that the second publisher performed much better than the first publisher, the second publisher's install numbers cover twice the period of time.

In such an example, non-windowed install contributions can be used to compare these two publishers. The contribution length for this example may be set to 30 days. The first publisher may be credited for an additional 60 non-windowed install contributions during the 16 days between the end of the publisher's attribution window and the contribution length, and the second publisher may be credited for an additional 5 non-windowed install contributions during the 2 days between the end of the publisher's attribution window and the contribution length. Hence, the total attributed installs, install assists, and non-windowed install contributions can be compared for the first publisher (100+60=160 total) and the second publisher (150+5=155 total) to provide a better comparison of the relative overall performance of the two publishers.

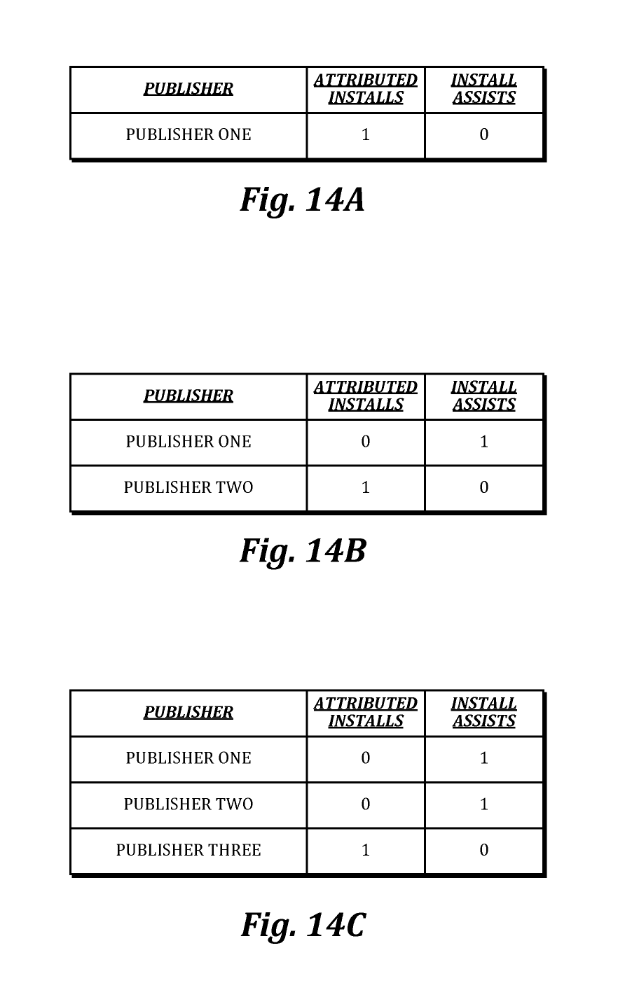

FIGS. 14A-14C are tables that illustrate three separate non-limiting examples of scenarios in which credit for attributed installs and install assists is assigned according to various aspects of the present disclosure. For the examples illustrated in FIGS. 14A-14C, each of the publishers is associated with an attribution window of seven days, and the application install date is Apr. 26, 2014. While scenarios are provided for assigning credit for installs, one of ordinary skill in the art will recognize that similar examples would be possible for assigning credit for re-engagements. Also, while scenarios are discussed for assigning credit to publishers, one of ordinary skill in the art will recognize that similar examples would be possible for any other type of ad provider.

In FIG. 14A, Publisher One is associated with a matching click record with a timestamp on Apr. 21, 2014 (five days before the application install date). No other matching click record is found by the tracking system 120 with a timestamp later than Apr. 21, 2014, and on or before the application install date. Accordingly, Publisher One has been credited for an attributed install.

In FIG. 14B, Publisher One is associated with a matching click record with a timestamp on Apr. 21, 2014 (five days before the application install date). Publisher Two is associated with a matching click record with a timestamp on Apr. 25, 2014. No other matching click records are found by the tracking system 120. Accordingly, Publisher Two has been credited for an attributed install, because their click was the last click before install. In addition, Publisher One has been credited for an install assist, because they had a click that was not the last click before install but that nevertheless occurred within their attribution window.

In FIG. 14C, Publisher One is associated with a matching click record with a timestamp on Apr. 20, 2014 (six days before the application install date). Publisher Two is associated with a matching click record with a timestamp on Apr. 25, 2014 (five days before the application install date). Publisher Three is associated with a matching click record with a timestamp on Apr. 25, 2014. No other matching click records are found by the tracking system 120. Accordingly, Publisher Three has been credited for an attributed install, as their click was the last click before install. Both Publisher One and Publisher Two have been credited for install assists, because both had clicks that were not the last click before install, but that did occur within their attribution windows.

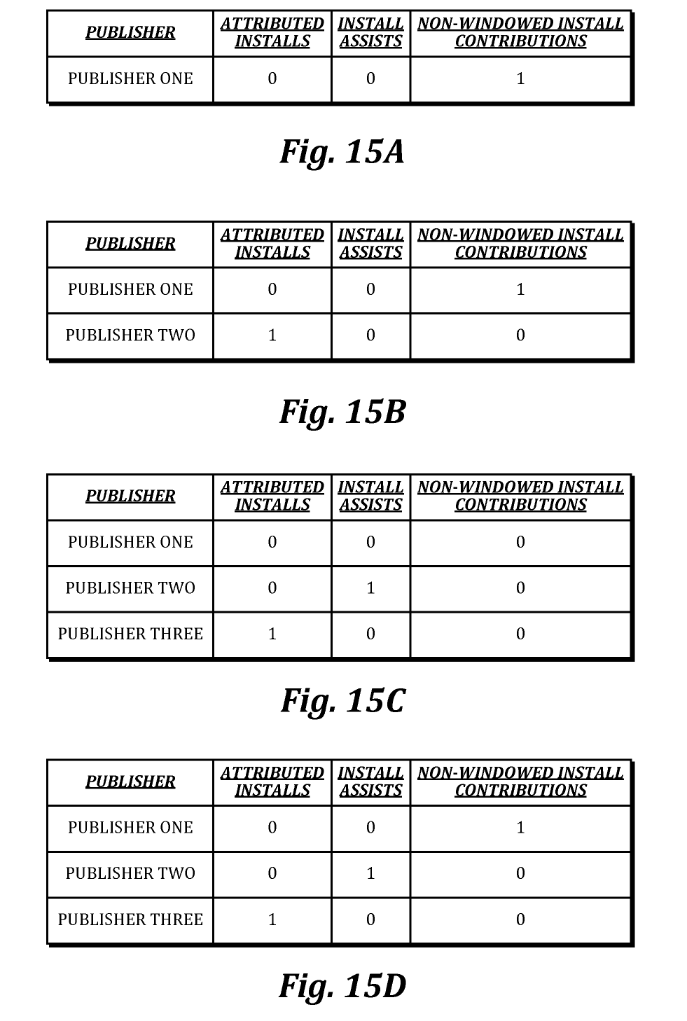

FIGS. 15A-15D are tables that illustrate three separate non-limiting examples of scenarios in which credit for attributed installs, install assists, and non-windowed install contributions is assigned according to various aspects of the present disclosure. For the examples illustrated in FIGS. 15A-15D, the application install date is Apr. 26, 2014, and the contribution window for all publishers is set to 30 days. Publisher One is associated with an attribution window of 14 days, while Publisher Two and Publisher Three are associated with attribution windows of 7 days. One of ordinary skill in the art will again recognize that while the examples discuss credit for installs, similar scenarios could occur for assigning credit for re-engagements. Also, while scenarios are discussed for assigning credit to publishers, one of ordinary skill in the art will recognize that similar examples would be possible for any other type of ad provider.

In FIG. 15A, Publisher One is associated with a matching click record with a timestamp on Apr. 6, 2014 (twenty days before the application install date). No other matching click records are found by the tracking system 120. Even though the click associated with Publisher One is the last click before install, it lies outside of Publisher One's 14-day attribution window, and so cannot be credited as an attributed install. Instead of receiving no credit, Publisher One is credited for a non-windowed install contribution for its contribution to the eventual installation of the application.

In FIG. 15B, Publisher One is associated with a matching click record with a timestamp on Apr. 6, 2014 (twenty days before the application install date). Publisher Two is associated with a matching click record with a timestamp on Apr. 19, 2014 (seven days before the application install date). No other matching click records are found by the tracking system 120. Because Publisher Two is associated with the last click before install and the matching click occurred within Publisher Two's 7 day attribution window, Publisher Two is credited with an attributed install. Publisher One is credited with a non-windowed install contribution instead of an install assist, because the matching click associated with Publisher One was outside of Publisher One's 14-day attribution window.

In FIG. 15C, Publisher One is associated with a click record with a timestamp on Mar. 1, 2014 (56 days before the application install date). Publisher Two is associated with a matching click record with a timestamp on Apr. 19, 2014 (seven days before the application install date). Publisher Three is associated with a matching click record with a timestamp on Apr. 25, 2014 (one day before the application install date). Because Publisher Three is associated with the last click before install and the matching click record occurred within Publisher Three's 7 day attribution window, Publisher Three is credited with an attributed install. Publisher Two is credited with an install assist, because their matching click was not the last click before install, but did occur within Publisher Two's 7-day attribution window. Publisher One does not receive any credit, because the click associated with Publisher One was outside of the contribution window. In some embodiments, the click associated with Publisher One may not be considered a matching click record due to the fact that it is outside of the contribution window. In some embodiments, the click associated with Publisher One may be considered a matching click record, but may not receive any credit due to the fact that it is outside of the contribution window.

In FIG. 15D, Publisher One is associated with a matching click record with a timestamp on Apr. 6, 2014 (twenty days before the application install date). Publisher Two is associated with a matching click record with a timestamp on Apr. 19, 2014 (seven days before the application install date). Publisher Three is associated with a matching click record with a timestamp on Apr. 25, 2014 (one day before the application install date). Because Publisher Three is associated with the last click before install and the matching click record occurred within Publisher Three's 7 day attribution window, Publisher Three is credited with an attributed install. Publisher Two is credited with an install assist, because their matching click was not the last click before install, but did occur within Publisher Two's 7-day attribution window. Publisher One is credited with a non-windowed install contribution, because the matching click associated with Publisher One was outside of Publisher One's 14-day attribution window.

In some embodiments, only one credit is provided to a given publisher in association with a given action. In such embodiments, the highest form of available credit may be provided to the publisher if there is more than one matching click. For example, returning to FIG. 15D, Publisher One may be associated with another matching click record with a timestamp on Apr. 5, 2014 (twenty-one days before the application install date), Publisher Two may be associated with a matching click record with a timestamp on Apr. 7, 2014 (nineteen days before the application install date), and Publisher Three may be associated with additional matching click records with timestamps on Apr. 24, 2014 (two days before the application install date) and Apr. 8, 2014 (eighteen days before the application install date). Even with these extra click records, the credit illustrated in FIG. 15D would not change. Both of Publisher One's click records fall outside the attribution window and within the contribution window, and so credit for one non-windowed install contribution is provided to Publisher One. Publisher Two's additional matching click record from April 7 falls outside the attribution window and within the contribution window. However, because Publisher Two has received credit for an install assist for its matching click record from April 19, credit is not given for a non-windowed install contribution, because the install assist is a higher form of credit. Likewise, because Publisher Three has received credit for an attributed install (the highest form of credit), no credit is assigned to Publisher Three for either additional matching click record from April 24 or April 8. Stated another way, a publisher may only be given credit for its matching click record that occurred closest in time to the tracked action. In other embodiments, credit may be assigned for every matching click record associated with a publisher.

In the examples provide above in FIGS. 14A-14C and 15A-15D, dates of the clicks and installs are compared. The discussion of the examples is limited to comparing dates for ease of discussion only. One of skill in the art will recognize that the comparisons may be based on both a date and a time, such that, for example, a click that occurs on Apr. 25, 2014 at 1:00 PM would be considered earlier than a click that occurs on Apr. 25, 2014, at 1:01 PM. Attribution windows and contribution windows may also be specified in any suitable time increment, such as minutes, hours, seconds, days, or any other suitable time increment.

### Post-Conversion Attribution

As discussed above, the use of the tracking system 120 allows installation activity on end user computing devices 162 to be attributed to advertising providers regardless of an inability to store information on the devices 162 or communicate between local applications on the devices 162. One issue that arises when attempting to collect tracking data using the techniques described above is that the tracking system 120 may receive information out of chronological order. For example, install information may be reported directly to the tracking system 120 by the end user computing device 162 upon first execution of the application 214 as discussed above with respect to block 365 of FIG. 6A, while user click information may be transmitted to the tracking system 120 by an advertisement providing computing device 242 as described in block 630 of FIG. 7A. In such embodiments, the advertisement providing computing device 242 may not transmit the information to the tracking system 120 immediately as received, but may instead store the information for delivery to the tracking system 120 in periodic batches. So, in the interest of collecting data from all possible sources in order to improve the accuracy of the data collected by the tracking system 120, it is possible that the tracking system 120 will receive the install information before it receives the user click information that led to the install, or that the tracking system 120 will otherwise receive user click information from various sources in non-chronological order. Accordingly, in some embodiments of the present disclosure, the tracking system 120 is configured to compensate for information that is received late or out of order as appropriate as discussed below.

An example install tracking link generated by the tracking link page 222 for a first publisher may be as follows:
http://hastrk1.com/serve?action=install&publisher_id=1&site_id=123&device_id={device_id}

In order to enable post-conversion processing for a second publisher, a flag may be added to the tracking link as follows:
http://hastrk1.com/serve?action=install&publisher_id=2&site_id=123&device_id={device_id}&post_conversion=1

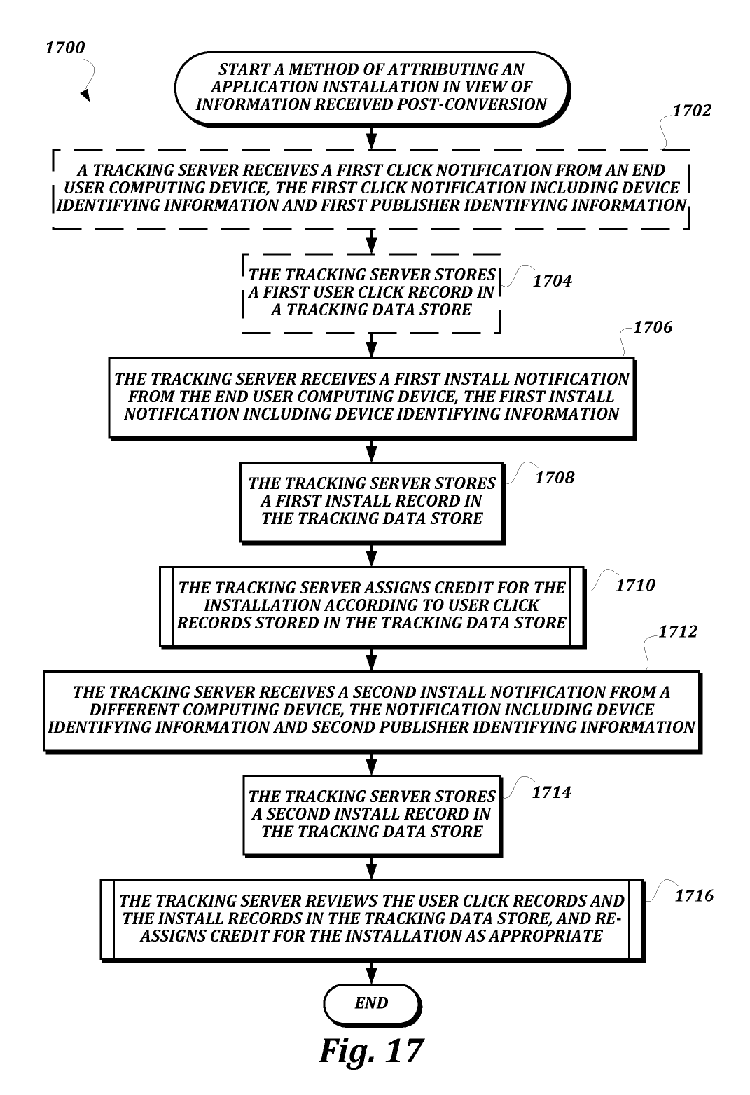

FIG. 17 is a flowchart that illustrates an exemplary embodiment of a method 1700 of attributing an application installation in view of information received post-conversion according to various aspects of the present disclosure.

From a start block, the method 1700 proceeds to optional block 1702, where a tracking server 122A receives a first click notification from an end user computing device 162A, the first click notification including device identifying information and a first publisher identifier. As discussed above, the device identifying information may include one or more of a device identifier, a user identifier, a tracking identifier, and/or the like, and the first publisher identifying information may include one or more of a site ID value, a publisher identifier, a campaign ID value, an offer ID value, and/or the like. The method 1700 then proceeds to optional block 1704, where the tracking server 122A stores a first user click record 126 in a tracking data store 125. The first user click record 126 is based on the information included in the first click notification, and may include the device identifying information and the first publisher identifying information in order to enable association of the first user click record 126 with other records in the tracking data store 125 related to the same end user computing device 162A, the same application, or the same publisher. Storing such information in the tracking data store 125 enables such associations without storing tracking information in the restricted local memory of the end user computing device 162A. Blocks 1702 and 1704 are illustrated and described as being optional because, in some embodiments and as described further below, the method 1700 may process a conversion in which no click notifications were received prior to the processing of the conversion (as illustrated in block 480 of FIG. 8 and described above).

At block 1706, the tracking server 122A receives a first install notification from the end user computing device 162A, the first install notification including device identifying information. The first install notification may also include information identifying the installed application such as a site ID value or package name value. Next, at block 1708, the tracking server 122A stores a first install record 128 in the tracking data store 125. The first install record 128 includes the device identifying information and the site ID value/package name from the first install notification. The device identifying information and site ID value/package name value are similar to those described above and are usable to match the first install notification to corresponding user click records 126.

The method 1700 then advances to procedure block 1710, where the tracking server 122A assigns credit for the installation according to user click records 126 stored in the tracking data store 125. The method 1700 may use any suitable procedure for assigning credit, including but not limited to the method 430 of assigning credits for attributed installs illustrated in FIG. 8 and described above, the techniques for assigning credit for install assists and non-windowed install contributions described above, and/or combinations thereof.

Next, at block 1712, the tracking server 122A receives a second install notification from a different computing device, including device identifying information and second publisher identifying information. As discussed above, in some embodiments the different computing device may be the advertisement providing computing device 242, while the first install notification was transmitted directly from the end user computing device 162A. In some embodiments, the different computing device may be any other computing device that received the install notification. In some embodiments (for example, in embodiments wherein the end user computing device 162A batches notifications for non-contemporaneous upload), the first install notification may be received from the advertisement providing computing device 242, and the second install notification may be received from the end user computing device 162A. At block 1714, the tracking server 122A stores a second install record 128 based on the second install notification in the tracking data store 125.

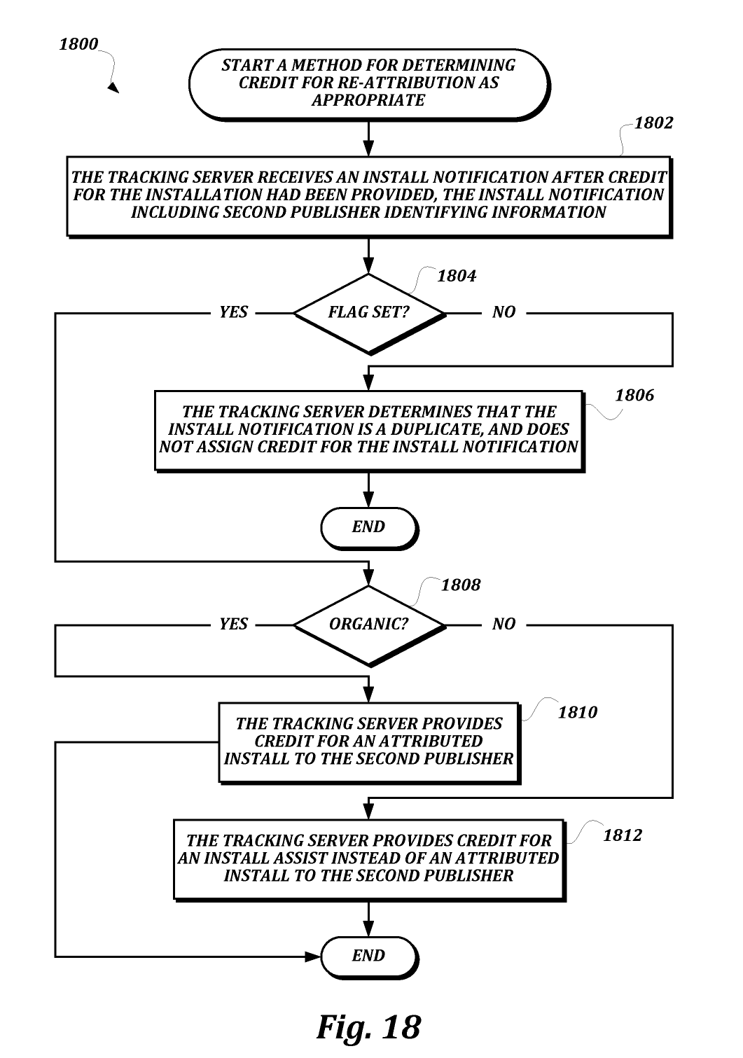

The method 1700 then proceeds to procedure block 1716, where the tracking server 122A reviews the user click records 126 and the install records 128 in the tracking data store, and re-assigns credit for the installation as appropriate. One non-limiting example of a technique for re-assigning credit as appropriate is illustrated in FIG. 18 and described below. The method 1700 then proceeds to an end block and terminates.

FIG. 18 is a flowchart that illustrates an exemplary embodiment of a method 1800 for determining credit for re-attribution as appropriate according to various aspects of the present disclosure. The method 1800 is an example of a procedure suitable for use at procedure block 1716 illustrated in FIG. 17 and described above. As such, it assumes that a conversion has been processed for a first install record, which has been attributed as either an organic install or as an attributed install to a first advertisement provider (also referred to herein as the first publisher).

From a start block, the method 1800 proceeds to block 1802, where the tracking server 122A receives an install notification after credit for the installation had been provided. In some embodiments, the tracking server 122A may add the install notification to a queue of tracking information 182 to be processed periodically. In some embodiments, the tracking server 122A may check the tracking data store 125 to determine whether a conversion had previously been processed that matches the newly received install notification. Though the illustrated method 1800 assumes that a conversion had previously been processed, the method 1800 may redirect to the start of the method 1700 illustrated in FIG. 17 if it is determined that no conversion had previously been processed.

The method 1800 then proceeds to decision block 1804, where the tracking server 122A determines whether a re-attribution flag is set within the install notification. In response to determining that the re-attribution flag is not set, the result of the test at decision block 1804 is NO, and the method 1800 proceeds to block 1806. At block 1806, the tracking server 122A determines that the install notification represents a duplicate of a record previously processed as part of the initial conversion attribution processing, and does not assign credit for the install notification. The method 1800 then proceeds to an end block and terminates.

Otherwise, in response to determining that the re-attribution flag is set, the result of the test at decision block 1804 is YES, and the method 1800 proceeds to another decision block 1808. In some embodiments, the re-attribution flag for identifying a post-conversion request that should be processed is not used. In such embodiments, instead of checking for the re-attribution flag, the tracking server 122A searches for a matching previous install record. If a matching previous install record is found, and if the newly received install notification includes new information that was not present in the matching previous install record, then the method 1800 will proceed as if the result of the test at decision block 1804 is YES. Otherwise, if a matching previous install record is not found or if the newly received install notification does not include new information, then the method 1800 will proceed as if the result of the test at decision block 1804 is NO.

At decision block 1808, the tracking server 122A performs a test to determine whether the installation was previously determined to be an organic installation. The tracking server 122A may do this by retrieving the previously generated install record 128 and extracting an indication of the organic install from the install record 128. As discussed above, the installation may have been determined to be an organic installation if there were no matching user click records 126 within the applicable attribution window at the time the conversion was processed.

If the tracking server 122A determines that the install was previously attributed as an organic install, then the result of the test at decision block 1808 is YES, and the method proceeds to block 1810. At block 1810, the tracking server 122A provides credit for an attributed install to the second publisher. The method 1800 then proceeds to an end block and terminates.

Otherwise, if the tracking server 122A determines that the install was previously attributed to a different publisher (instead of being an organic install), then the result of the test at decision block 1808 is NO, and the method 1800 proceeds to block 1812. At block 1812, the tracking server 122A provides credit for an install assist instead of an attributed install to the second publisher. This is an install assist “instead” of an attributed install because the second publisher may have been eligible to be credited for an attributed install if the newly obtained install notification was received before the initial attribution to the first publisher. However, in some embodiments (such as the illustrated embodiment), attributed installs are not modified once they are granted to a given publisher, even if later-obtained information shows that a different publisher should have received the attributed install credit. This simplification helps to improve efficiency in that a relatively costly and difficult to synchronize database update does not have to be performed to provide some type of credit for the second publisher. It also helps improve accuracy because total numbers for attributed installs will stay consistent from one report to another, in that they will never be reduced. Of course, in other embodiments, credit for an attributed install may be re-assigned to the second publisher. The method 1800 then proceeds to an end block and terminates.

While the processing of install notifications is primarily discussed in the description of method 1800, in some embodiments, similar processing may be performed for user click notifications received after initial conversion processing. Likewise, in some embodiments, similar processing may periodically be performed for user click records and/or install records stored in the tracking data store 125, instead of for user click notifications and/or install notifications upon receipt. Also, while the re-attribution of installs is described above, in some embodiments, similar techniques may be used to re-attribute in-application events or re-engagement. Also, while user click notifications and user click records 126 are discussed above, one of ordinary skill in the art will recognize that similar techniques for attribution may be used with respect to impression notifications and impression records that are received by the tracking engine 124 and stored in the tracking data store 125. In some embodiments, both user click records and impression records (collectively referred to as ad records) may be taken into account for attribution.

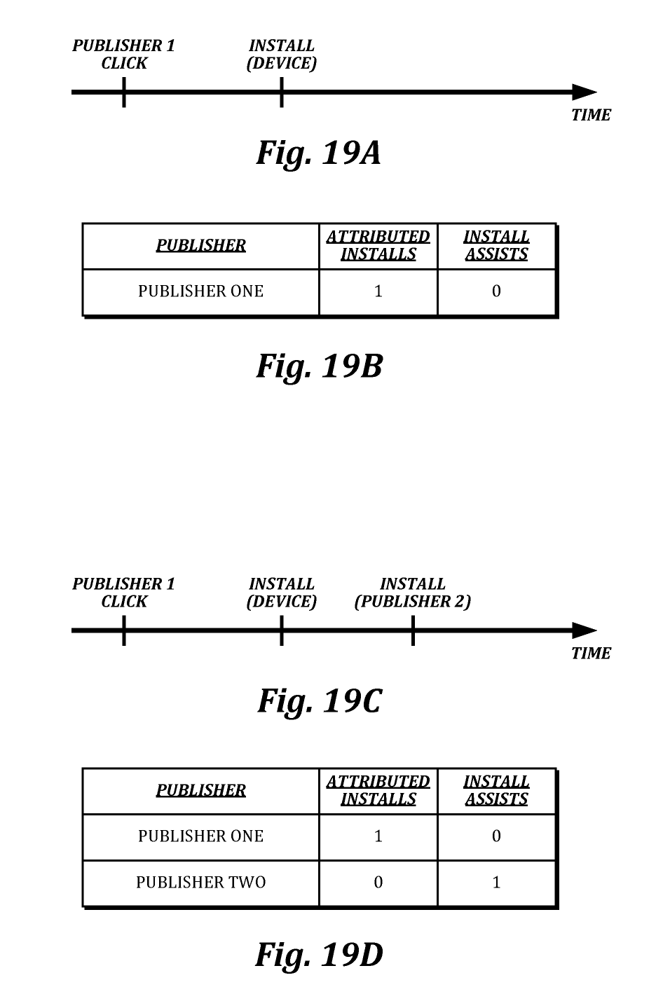

FIGS. 19A-19D illustrate how particular events would be attributed during post-conversion processing by some embodiments of the present disclosure. FIG. 19A is a timeline illustrating information possessed by the tracking system 122A at the point of initial conversion processing. The timeline shows that a user click notification identifying Publisher 1 is received, and then an install notification is received from the end user computing device. Upon receipt of the install notification, credit is assigned for the installation (see procedure block 1710). FIG. 19B illustrates that Publisher 1 is assigned credit for an attributed install by virtue of being the last click before the install.

FIG. 19C is an update of the timeline of FIG. 19A illustrating information possessed by the tracking system 122A at a time after the conversion. The timeline shows that an install notification was received from Publisher 2 after the conversion was processed. FIG. 19D illustrates that Publisher 2 is assigned credit for an install assist based on the post-conversion install notification, and that Publisher 1 retains its attributed install credit.

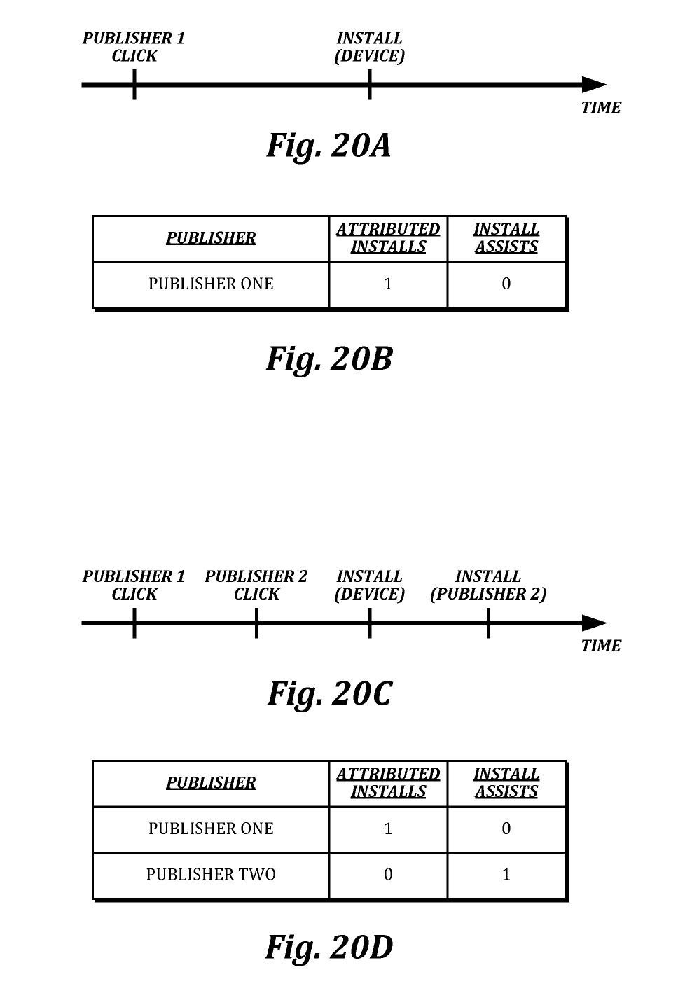

FIGS. 20A-20D illustrate how other events would be attributed during post-conversion processing by some embodiments of the present disclosure. FIG. 20A is a timeline illustrating information possessed by the tracking system 122A at the point of initial conversion processing. The timeline shows that a user click notification identifying Publisher 1 is received, and then an install notification is received from the end user computing device. Upon receipt of the install notification, credit is assigned for the installation (see procedure block 1710). FIG. 20B illustrates that Publisher 1 is assigned credit for an attributed install by virtue of being the last click before the install.

FIG. 20C is an update of the timeline of FIG. 20A illustrating information possessed by the tracking system 122A at a time after the conversion. The timeline shows that an install notification was received from Publisher 2 after the conversion was processed, as was a user click notification that identifies Publisher 2. The user click notification identifying Publisher 2 indicates that the click occurred after the click from Publisher 1. FIG. 20D illustrates that Publisher 2 is assigned credit for an install assist, and Publisher 1 retains its credit for the attributed install. If the tracking system 122A had possessed the user click notification identifying Publisher 2 at the point of the initial conversion processing, then Publisher 2 would have been assigned the credit for the attributed install by virtue of being the last click before install. However, because the illustrated embodiment of the tracking system 122A does not reassign attributed install credits during post-conversion processing, Publisher 2 is instead given credit for an install assist.

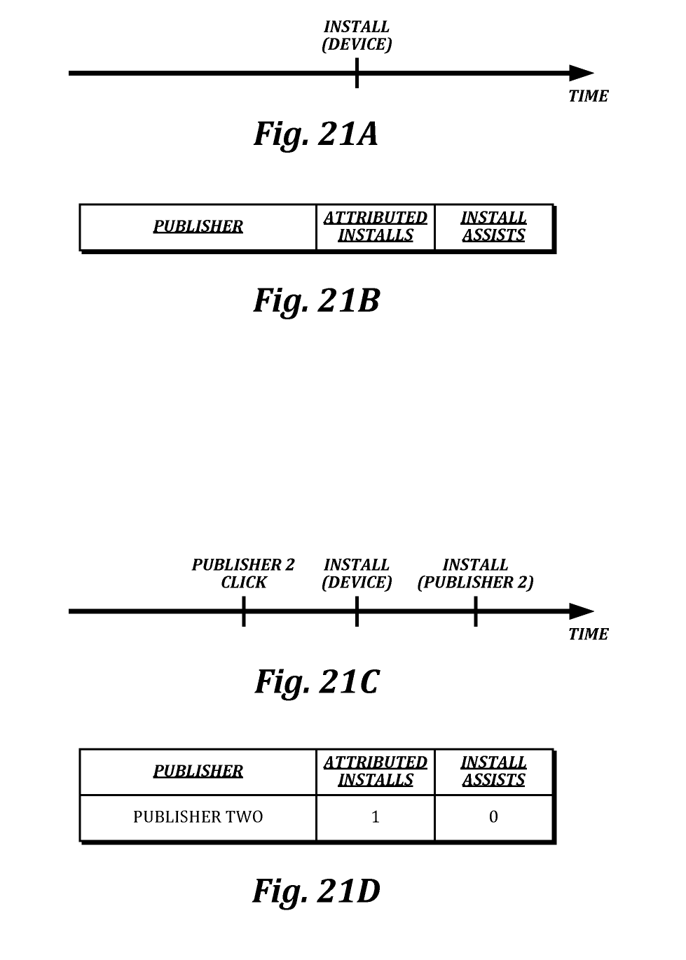

FIGS. 21A-21D illustrate how additional events would be attributed during post-conversion processing by some embodiments of the present disclosure. FIG. 21A is a timeline illustrating information possessed by the tracking system 122A at the point of initial conversion processing. The timeline shows that no user click notifications were received before receiving the install notification from the end user computing device. FIG. 21B illustrates that no credit has been assigned during conversion processing, and the installation is considered an organic install.

FIG. 21C is an update of the timeline of FIG. 21A illustrating information possessed by the tracking system 122A at a time after the initial conversion processing. The timeline shows that an install notification was received from Publisher 2 after the conversion was processed, as was a user click notification that identifies Publisher 2. The user click notification identifying Publisher 2 indicates that the click occurred before the installation. FIG. 21D illustrates that Publisher 2 is assigned credit for an attributed install, because the tracking system 122A is configured to re-attribute organic installs during post-conversion processing.

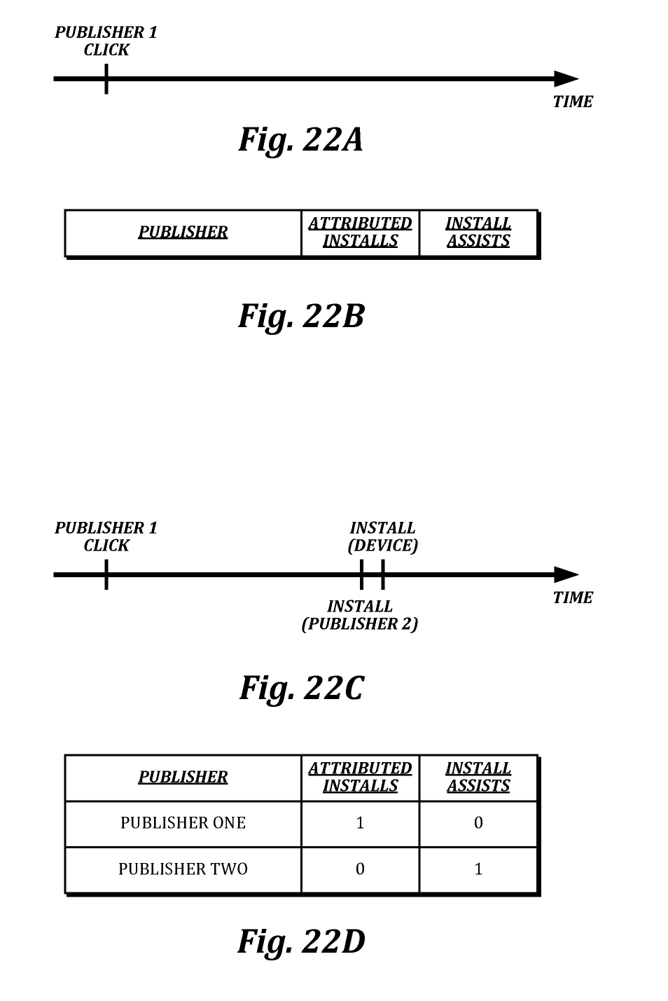

In some embodiments, the tracking system 122A may be configured to delay processing of information received from third parties in order to give priority to information received from the tracking SDK or otherwise reported directly to the tracking system 122A from end user computing devices. FIGS. 22A-22D illustrate an example of how events may be attributed during post-conversion processing by some such embodiments of the present disclosure. FIG. 22A is a timeline illustrating information possessed by the tracking system 122A at a first point in time. The tracking system 122A has received a user click notification identifying Publisher 1. However, no install notification has been received yet, so there is not yet anything to be attributed to Publisher 1. FIG. 22B illustrates that no credit has yet been assigned.

FIG. 22C is an update of the timeline of FIG. 22A illustrating information possessed by the tracking system 122A at a later time. For example, the illustrated embodiment of the tracking system 122A may be configured to delay processing of information received from third parties by a given period of time (such as an hour), and the install notification received from Publisher 2 is illustrated as having been received only 30 minutes before the install notification from the end user computing device. Accordingly, FIG. 22D illustrates that the attributed install credit is assigned to Publisher 1, because processing of the information received from Publisher 2 is still being delayed at the time the install notification was received from the end user computing device. Once the information received from Publisher 2 is processed, Publisher 2 is assigned credit for an install assist, because the attributed install credit was already provided to Publisher 1 and is not reassigned.

### Presentation of Metrics

Turning to FIG. 2D, the management interface (e.g., the reports page 224 illustrated in FIG. 11B) generated by the management interface engine 123 may be used to view portions of the tracking information 182 and generate reports based at least in part on the tracking information 182 stored in the tracking data store 125 on the storage service server 122B. One or more of the Advertisers/Merchants 130, the Mobile Advertising Networks 140, and/or the Mobile Advertising Publishers 150 may use the management interface (e.g., the reports page 224 illustrated in FIG. 11B) generated by the management interface engine 123 to generate reports. For ease of illustration, in FIG. 2D, the customer computing device 132A is illustrated using the management interface to generate the reports page 124 illustrated in FIG. 11B.

In the embodiment illustrated in FIG. 2D, the computing device 132A executes a conventional Internet browser application 800. The Internet browser application 800 displays webpages generated by the management interface engine 123 and transmits user input received from the end user to the management interface engine 123.

In FIG. 2D, an arrow “A16” represents a request sent by the Internet browser application 800 (in response to a user instruction received via a user interface) to the management interface engine 123 for the reports page 224.

When the management interface engine 123 receives the request, the management interface engine 123 sends a request to the tracking data store 125 for information used to generate the reports page 224. This request is represented in FIG. 2D by arrow “A17.”

In response to the request sent by the management interface engine 123, the tracking data store 125 obtains the information requested and sends the information to the management interface engine 123. This request is represented in FIG. 2D by arrow “A18.”

After the management interface engine 123 receives the information from the tracking data store 125, the management interface engine 123 generates the reports page 224 and sends it to the Internet browser application 800 for display thereby to the end user. This request is represented in FIG. 2D by arrow “A19.”

By way of non-limiting examples, the management interface engine 123 may allow the Advertisers/Merchants 130, the Mobile Advertising Networks 140, and/or the Mobile Advertising Publishers 150 to access one or more of the following types of information:

1. User Click Data;

2. User Install Data;

3. User Event Data;

4. Publisher Payouts;

5. Install Rate;

6. Cost Per Click;

7. Revenue Per Install; and

8. Other Relevant Information, including attributed installs and/or re-engagements, install and/or re-engagement assists, and non-windowed install and/or re-engagement contributions.

Depending upon the implementation details, the management interface engine 123 may be used to aggregate information and provide analytics (e.g., graphs) to the Advertisers/Merchants 130, the Mobile Advertising Networks 140, and/or the Mobile Advertising Publishers 150 that may be used thereby to improve the effectiveness of advertising campaigns.

The storage service server 122B may organize and index the tracking information 182. Optionally, the tracking server 122A may include a storage engine (not shown) substantially similar to the storage engine 125 executing on the storage service server 122B.

FIG. 11B is an illustration of an exemplary reports page 224 generated by the management interface engine 123. The reports page 224 includes a graph 802. Each line (e.g., lines 804A and 804B) on the graph 802 depicts data for a select application (e.g., the application 214). For ease of illustration, in FIG. 11B, the graph 802 includes the line 804A, which depicts data for the application 214, and the line 804B, which depicts data for a different application (“Application B”) marketed by the same customer as the application 214. Thus, on the graph 802, multiple lines may be used to depict data for multiple applications.

The x-axis is a predetermined date range. A user input 806 may be used to specify the predetermined date range. The y-axis is a number of events tracked by the tracking system (e.g., installs, clicks, install assists, non-windowed install contributions, and the like). A user input 810 may be used to select the type of event. For example, the user input 810 may allow the user to select “installs,” “clicks,” and/or the like.

A user input 808 may be used to select “publishers,” “organics,” or “totals.” If “publishers” is selected, only events attributable to an advertising provider will be included in the graph 802. If “organics” is selected, only events not attributable to an advertising provider will be included in the graph 802. If “totals” is selected, all events will be included in the graph 802.

In FIG. 11B, “publishers” has been selected in the user input 808, and “installs” has been selected in the user input 810. Thus, the line 804A depicts a number of installs of the application 214 from April 10 to April 17 that were attributed to one of the advertising providers. The graph 802 may be used to evaluate the overall effectiveness of an advertising campaign.

The reports page 224 includes an area 820 in which information about each of the applications marketed by the customer may be displayed. In this example, buttons or links are associated with each application. The customer may select the buttons or links to view more information about each application. In FIG. 11B, the buttons include a publishers button 821, a campaigns button 822, and an organic button 823. When one of these buttons is clicked, a new table or graph (not shown) may be displayed that may help the customer evaluate (1) the effectiveness of particular publishers with respect to getting users to download the application, (2) the effectiveness of particular campaigns, and/or (3) the number of applications that are downloaded organically.

The reports page 224 includes a performance graph 830 and a budget graph 832. The graphs 830 and 832 may be used to show total customer numbers for all of the customer's applications. For example, the performance graph 830 may be used to depict a total number of clicks and installs the customer is experiencing for all of its applications over the predetermined date range. The budget graph 832 may be used to depict a payout amount and an amount of revenue generated by all of the customer's applications over the predetermined date range. The graphs 830 and 832 may help provide an overview of how well the customer is doing overall.

In embodiments in which action assists and/or non-windowed action contributions are tracked by the tracking system 120, such information may also be presented in the reports page 224 or in another suitable interface. For example, the reports page 224, when presented to an advertiser 130, may allow the advertiser 130 to select one or more ad providers, and may then present a comparison of attributed installs, install assists, and/or non-windowed install contributions for each of the ad providers in graph or tabular format. This allows the advertiser 130 to determine an overall effectiveness of an advertising campaign, and the comparison of attributed installs to install assists can help the advertiser 130 determine which ad providers are effectively driving installations, and which ad providers are effectively building awareness. The presentation of non-windowed install contribution information also allows the advertiser 130 to meaningfully compare ad provider performance even for ad providers that have attribution windows of different lengths.

Access to reporting information may not be limited to advertisers 130. In some embodiments, advertising publishers 150 and/or advertising networks 140 may be provided access to reporting data as well. In some embodiments, advertising publishers 150 may be provided access to a subset of the tracking information and metrics in order to allow the advertising publishers 150 to analyze their performance without disclosing sensitive information. For example, in some embodiments, advertising publishers 150 may be provided access to logs of attributed installs or re-engagements for which they have been provided credit, but they may be prevented from accessing logs of assists or non-windowed contributions and may instead only be given access to aggregated performance counts. Further, information that falls outside of the publisher's attribution window may be hidden from the publisher, even if it is collected and made available to advertisers 130. For example, non-windowed install contributions may be hidden from advertising publishers 150 to prevent advertising publishers 150 from using the information to change their billing models to maximize total potential conversions (e.g., by altering their attribution window policies).

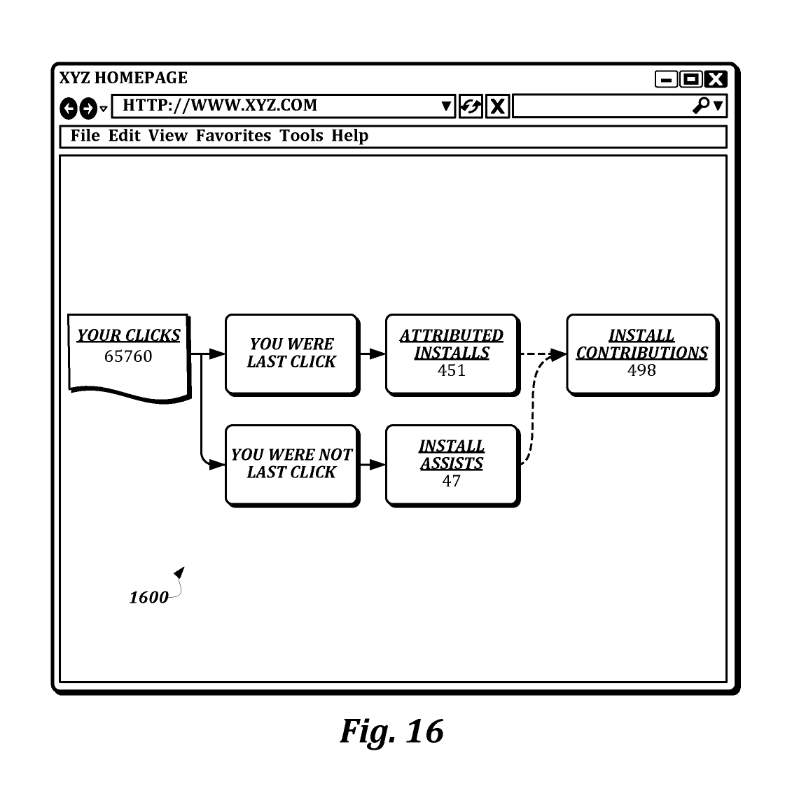

FIG. 16 is a drawing of an exemplary embodiment of an interface for presenting tracking information to a publisher according to various aspects of the present disclosure. The interface 1600 is illustrated as being presented within a traditional web browser, but in other embodiments, the interface 1600 may be presented to the publisher using any suitable technique. The interface 1600 includes a presentation of a count of overall clicks, attributed installs, install assists, and publisher install contributions (attributed installs plus install assists) that have been tracked for a given publisher. The information is presented in a flowchart format to aid in understanding. In some embodiments, the interface 1600 may also include similar information presented in tabular or graph form.

While the drawings and description of reporting interfaces provided above primarily discuss graphical interfaces used to present the tracking information, in some embodiments, such information may also be programmatically accessible. In some embodiments, an application programming interface (API) may be provided that allows advertisers, publishers, or other entities to programmatically access tracking information collected by the tracking system 120 instead of accessing the information through the graphical interfaces described above.

Returning to FIG. 1, as explained above, the system 100 may be used to track end user downloads of software applications and usage of said applications after installation. The system 100 may also be used to provide statistics and/or analytics to the Advertisers/Merchants 130, the Mobile Advertising Networks 140, and/or the Mobile Advertising Publishers 150 for the purpose of measuring the effectiveness of advertising campaigns.

### Computing Device

FIG. 12 is a diagram of hardware and an operating environment in conjunction with which implementations of the one or more computing devices of the system 100 may be practiced. The description of FIG. 12 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 12 includes a general-purpose computing device in the form of the computing device 12. Each of the computing devices of FIGS. 1 and 2A-2D (including the computing devices 122, 132, 142, 152, 162, 172, and 242) may be substantially identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface. The user interface is configured to display portions of the management interface (e.g., the tracking link page 222 illustrated in FIG. 11A, the reports page 224 illustrated in FIG. 11B, and the like) to the End Users 160.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 12 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods 200, 250, 290, 300, 400, 600, 700, and 430 illustrated in FIGS. 3, 4, 5, 6A, 6B, 7A, 7B, and 8, respectively) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Accordingly, the invention is not limited except as by the appended claims.

The embodiments of the invention in which an exclusive property or privilege is claimed are defined as follows:

1. A system for tracking installations of an application on end user computing devices that restrict inter-process communication and access to local storage, the system comprising:
a tracking data store configured to store a plurality of click records and a plurality of install records;
wherein each click record of the plurality of click records includes device identifying information, application identifying information, and a publisher identifier; and
wherein each install record of the plurality of install records includes device identifying information and application identifying information; and
a tracking server configured to:
receive a first install notification from a first computing device, the first install notification including first device identifying information that identifies a computing device on which the application was installed and application identifying information that identifies the application;
process a conversion for the application by:
searching the plurality of click records for a set of click records that match the first device identifying information and the application identifying information; and
assigning a first type of credit to a first publisher identified in a click record of the set of click records for the installation of the application, or identifying the installation as an organic install if the set of click records is empty;
after processing the conversion, receive a new notification from a second computing device different from the first computing device, the new notification including the first device identifying information and the application identifying information that identifies the application; and
use the new notification to modify credit assigned while processing the conversion.

2. The system of claim 1, wherein modifying credit assigned while processing the conversion includes assigning the first type of credit to a second publisher associated with the new notification in response to determining that the installation was previously identified as an organic install.

3. The system of claim 1, wherein modifying credit assigned while processing the conversion includes assigning a second type of credit to a second publisher associated with the new notification in response to determining that the first type of credit was previously assigned to the first publisher.

4. The system of claim 3, wherein the first type of credit is an attributed install, and wherein the second type of credit is an install assist.

5. The system of claim 1, wherein modifying credit assigned while processing the conversion includes ignoring the new notification in response to determining that the new notification does not include a post-conversion enablement flag.

6. The system of claim 1, wherein the new notification is a second click notification or a second install notification.

7. The system of claim 1, further comprising a management interface server configured to:
generate a web interface including prompts for an advertiser to select an ad publisher and to enable or disable post-conversion functionality;
automatically create a tracking link based on the information collected by the prompts in the web interface; and
provide the automatically created tracking link to the advertiser for association with an advertisement.

8. The system of claim 1, wherein the end user computing device is a smartphone.

9. A computer-implemented method for attributing an installation of an application on an end user computing device that restricts inter-process communication and access to local storage, the method comprising:
receiving, by a tracking server, a first install notification from a first computing device, the first install notification including first device identifying information that identifies the end user computing device and application identifying information that identifies the application;
processing, by the tracking server, a conversion for the application, wherein processing the conversion for the application includes:
searching a plurality of click records for a set of click records that match the first device identifying information and the application identifying information; and
assigning a first type of credit for the installation of the application to a first publisher identified in a click record of the set of click records in response to determining that the set of click records is not empty; and
identifying the installation as an organic install if the set of click records is empty;
after processing the conversion, receiving, by the tracking server, a new notification from a second computing device different from the first computing device, the new notification including the first device identifying information and the application identifying information that identifies the application; and
modifying, by the tracking server, credit assigned while processing the conversion using the new notification.

10. The method of claim 9, wherein modifying credit assigned while processing the conversion includes assigning the first type of credit to a second publisher associated with the new notification in response to determining that the installation was previously identified as an organic install.

11. The method of claim 9, wherein modifying credit assigned while processing the conversion includes assigning a second type of credit to a second publisher associated with the new notification in response to determining that the first type of credit was previously assigned to the first publisher.

12. The method of claim 11, wherein the first type of credit is an attributed install, and wherein the second type of credit is an install assist.

13. The method of claim 9, wherein modifying credit assigned while processing the conversion includes:
searching the new notification for a post-conversion enablement flag; and
ignoring the new notification in response to determining that the new notification lacks the post-conversion enablement flag.

14. The method of claim 9, wherein the new notification is a second click notification or a second install notification.

15. A computer-readable medium having computer-executable instructions stored thereon that, in response to execution by one or more processors of a tracking server, cause the tracking server to perform actions for attributing an installation of an application on an end user computing device that restricts inter-process communication and access to local storage, the actions comprising:
receiving, by the tracking server, a first install notification from a first computing device, the first install notification including first device identifying information that identifies the end user computing device and application identifying information that identifies the application;
processing, by the tracking server, a conversion for the application, wherein processing the conversion for the application includes:
searching a plurality of click records for a set of click records that match the first device identifying information and the application identifying information; and
assigning a first type of credit for the installation of the application to a first publisher identified in a click record of the set of click records in response to determining that the set of click records is not empty; and
identifying the installation as an organic install if the set of click records is empty;
after processing the conversion, receiving, by the tracking server, a new notification from a second computing device different from the first computing device, the new notification including the first device identifying information and the application identifying information that identifies the application; and
modifying, by the tracking server, credit assigned while processing the conversion using the new notification.

16. The method of claim 15, wherein modifying credit assigned while processing the conversion includes assigning the first type of credit to a second publisher associated with the new notification in response to determining that the installation was previously identified as an organic install.

17. The method of claim 15, wherein modifying credit assigned while processing the conversion includes assigning a second type of credit to a second publisher associated with the new notification in response to determining that the first type of credit was previously assigned to the first publisher.

18. The method of claim 17, wherein the first type of credit is an attributed install, and wherein the second type of credit is an install assist.

19. The method of claim 15, wherein modifying credit assigned while processing the conversion includes:
searching the new notification for a post-conversion enablement flag; and
ignoring the new notification in response to determining that the new notification lacks the post-conversion enablement flag.

20. The method of claim 15, wherein the new notification is a second click notification or a second install notification.
